(19) United States
(12) Patent Application Publication
(10) Pub. No.: US 2006/0274731 A1
(43) Pub. Date: Dec. 7, 2006

(54) Voice processing device, communication apparatus and program product

(75) Inventor: Tomohiro Ito, Mizuho-shi (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 11/436,645

(22) Filed: May 19, 2006

(30) Foreign Application Priority Data
May 20, 2005 (JP) 2005-148631
May 31, 2005 (JP) 2005-159970

(51) Int. Cl. H04L 12/66

(52) U.S. Cl. 370/352

(57) ABSTRACT

A voice processing device that includes: a measurement unit that measures a voice volume level of a voice signal transmitted from a remote communication apparatus; and a signal processing unit that, on the basis of a peak value of the voice volume level measured by the measurement unit, performs a signal processing determined according to the peak value with respect to a voice signal transmitted from/to the remote communication apparatus.

### CROSS REFERENCE TO RELATED APPLICATION

This application claims priority from Japanese Patent Applications No. 2005-148631, filed on May 20, 2005, and No. 2005-159970 filed on May 31, 2005, the entire subject matter of which is incorporated herein by reference.

### TECHNICAL FIELD

Aspects of the present invention relate to a voice processing device that performs a signal processing for changing a voice volume or a voice quality with respect to a voice signal transmitted from/to a remote communication apparatus, a communication apparatus having the voice processing device, and a program product causing a computer to function as the voice processing device.

Also, aspects of the present invention relate to a communication apparatus connected to a relay device, which is connected to both an IP network and a PSTN network, such that the communication apparatus can use each of the IP network and the PSTN network as a communication network.

### BACKGROUND

A conventional device that changes a voice volume level with respect to a voice signal transmitted from/to a remote communication apparatus is disclosed in JP-A-7-177085, for example.

The device disclosed in JP-A-7-177085 determines whether a sound transmitted from/to the remote communication apparatus is a voice on the basis of an analysis on the regression of voice data, integrates frame energy with respect to a plurality of frames included within a period of time of about several hundred milliseconds, and determines the voice volume level on the basis of the integrated value.

However, in a technique disclosed in JP-A-7-177085, the variation of the voice volume level cannot be detected until the period of time of about several hundred milliseconds passes. As a result, time deviation of at least several hundred milliseconds occurs between a time at which the voice volume level actually varies and a time at which the voice volume is changed after detecting the variation of the voice volume level. For this reason, in the case when the voice volume varies frequently, for example, in the case of a high-toned voice, it has been difficult to make a precise voice volume control with respect to the actual variation of the voice volume. As a result, it has been difficult to adjust the voice volume to an appropriate level that is easy to catch.

Further, in the technique disclosed in JP-A-7-177085, even in a case of a very low voice, the voice volume is changed as long as it is determined that the very low voice is a voice. As a result, even the voice volume of the very low voice that a person in communication does not normally need to hear, such as a voice generated by a person on the other party in communication, is changed.

Meanwhile, as an IP network is widely used in recent years, IP phones that perform communications through an IP network are becoming popular. In order to use an IP phone, a dedicated IP phone may be used. Alternatively, an existing analog phone may be used as the IP phone by adding an IP-phone adaptor, which is a relay device for connecting the existing analog phone to the IP network.

Such an IP-phone adapter has various names, such as an ADSL modem corresponding to an IP phone, a broadband router corresponding to an IP phone, or a VoIP adaptor, according to the difference of a connection type, a functional difference, or the like. Each of the devices described above is connected to both the IP network and the PSTN network and an analog phone is connected to the device through a single communication line.

Further, when the communication is performed by using an analog phone connected to the IP-phone adaptor, the IP-phone adaptor selects one of the IP network and the PSTN network according to a predefined setting or a user's setting and relays between the selected communication network and the analog phone.

However, when the IP-phone adaptor and the analog phone are used, there is a difference in the voice volume or the voice quality between a voice transmitted through an IP network and a voice transmitted through a PSTN network. For this reason, even though the voice characteristic of the analog phone is adjusted such that a voice transmitted through one of the IP network and the PSTN network is clearly audible, there is a problem in that a voice transmitted through the other network is not necessarily clearly audible.

For example, the difference in the voice volume due to the type of a communication network is also disclosed in JP-A-4-208742. JP-A-4-208742 discloses a technique in which it is identified whether the other party in communication is a subscriber of a digital network (ISDN network) or a subscriber of an analog network (PSTN network) on the basis of process contents within a process identifier included in messages received through a line of the digital network (ISDN network) and then the amplification of a voice is controlled according to the type of the identified network so as to equalize the signal level (voice volume level) of the voice.

However, the technique disclosed in JP-A-4-208742 is a technique on the assumption that the user's device is a digital phone connected to the digital network. In addition, in the technique disclosed in JP-A-4-208742, information is obtained on the basis of the content of a packet transmitted to the digital phone, and accordingly, the technique could not be used when the user's device is an analog phone connected to the IP phone adaptor.

Further, in the technique disclosed in JP-A-4-208742, it is only identified whether another device, which is the other party in communication, is a subscriber or not a subscriber of the digital network, and only one kind of a line (digital line) is used as a communication network for the user's device. That is, it is not possible to selectively use any one of the two kinds of lines (for example, an IP network and a PSTN network) as the communication network for the user's device. As such, a configuration for identifying the type of communication network for the user's device is not described in the technique.

Therefore, as describe above, even though there is a difference in the voice volume or the voice quality between a voice transmitted through an IP network and a voice transmitted through a PSTN network, the difference in the voice volume or the voice quality could not be solved in the technique disclosed in JP-A-4-208742.

### SUMMARY

Aspects of the present invention provide a voice processing device that is capable of performing a signal processing with respect to a voice signal in accordance with the variation of the voice volume level, even in the case where a voice volume level frequently varies. Further, a voice processing device that can perform a signal processing with respect to a voice signal in accordance with the variation of the voice volume, even in the case where a voice has a voice volume equal to or larger than a predetermined value, is provided. Furthermore, a communication apparatus having the voice processing device and a program product causing a computer to function as the voice processing device are provided.

Furthermore, other aspects of the invention provide a communication apparatus connected to a relay device, which is connected to both an IP network and a PSTN network, such that the communication apparatus can use each of the IP network and the PSTN network as a communication network.

### BRIEF DESCRIPTION OF THE DRAWINGS

FIG. 1 is a view schematically illustrating the configuration of a communication device according to an aspect of the invention;

FIG. 2 is an explanatory view illustrating an example of a handset sound parameter table;

FIG. 3 is a flow chart illustrating a signal processing with respect to a voice signal;

FIG. 4 is a view schematically illustrating the configuration of an overall communication system in which a multi-function product is connected;

FIG. 5 is a view illustrating an internal configuration of the multi-function product;

FIG. 6 is an explanatory view illustrating a handset sound parameter table;

FIG. 7 is a flowchart illustrating a communication process performed by the multi-function product;

FIG. 8 is a flow chart illustrating the communication process performed by the multi-function product;

FIG. 9 is a flow chart illustrating the communication process performed by the multi-function product;

FIG. 10 is a flow chart illustrating the communication process performed by the multi-function product;

FIG. 11 is a flow chart illustrating the communication process performed by the multi-function product;

FIG. 12 is a flow chart illustrating the communication process performed by the multi-function product;

FIG. 13 is a flow chart illustrating a communication relay process performed by an adaptor;

FIG. 14 is a flow chart illustrating the communication process performed by the adaptor;

FIG. 15 is a flow chart illustrating a facsimile transmission process performed by the multi-function product;

FIG. 16 is a flow chart illustrating the facsimile transmission process performed by the multi-function product;

FIG. 17 is a flow chart illustrating the facsimile transmission process performed by the multi-function product;

FIG. 18 is a flow chart illustrating the facsimile transmission process performed by the multi-function product; and

FIG. 19 is a flow chart illustrating the facsimile transmission process performed by the multi-function product;

### DETAILED DESCRIPTION

According to an aspect of the invention, there is provided a voice processing device including: a measurement unit that measures a voice volume level of a voice signal transmitted from a remote communication apparatus; and a signal processing unit that, on the basis of a peak value of the voice volume level measured by the measurement unit, performs a signal processing determined according to the peak value with respect to a voice signal transmitted from/to the remote communication apparatus.

In the voice processing device, when the signal processing unit performs a signal processing with respect to a voice signal transmitted from/to the remote communication apparatus, the signal processing unit performs a signal processing determined according to the peak value on the basis of the peak value of the voice volume level measured by the measurement unit. The peak value of the voice volume level can be instantly measured differently from, for example, an integrated value measured during a predetermined period of time.

Therefore, according to the voice processing device, even in the case when the voice volume frequently varies, for example, in the case of a high-toned voice, the signal processing can be performed without being delayed with respect to an actual variation of a voice volume. As a result, the voice can be corrected to have a clearer audible voice volume or voice quality.

Hereinafter, a first aspect of the invention will be described.

In the first aspect to be described below, a voice processing device is applied to a multi-function product (also referred to as an ‘MFP’) including a facsimile function, a phone function, a printer function, a scanner function, and a copying function. The voice processing device performs a signal processing for voice signals transmitted between the multi-function product and a remote communication apparatus when a phone function of the multi-function product is used.

[Configuration of Multi-Function Product]

First, a configuration of a multi-function product 1 will be described.

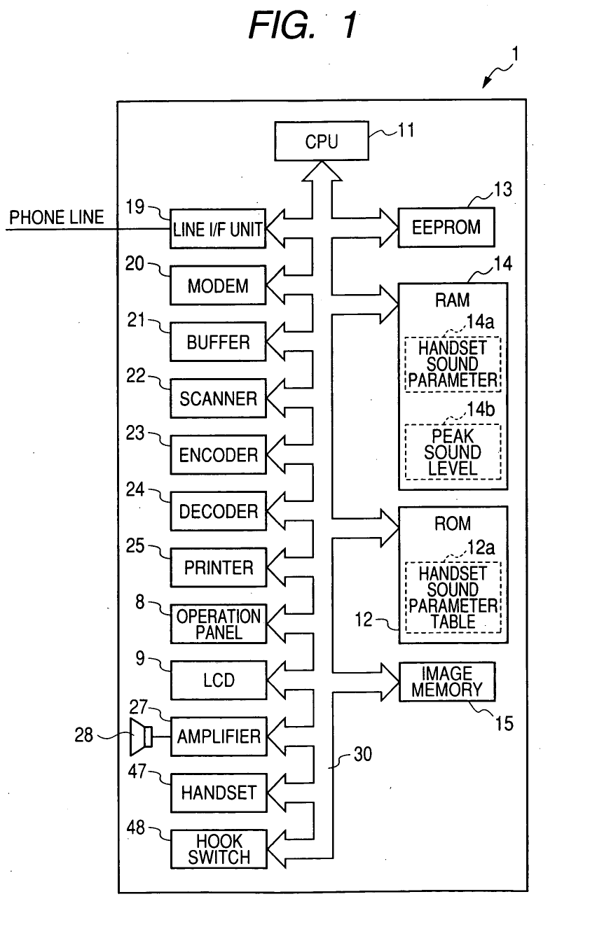

As shown in FIG. 1, the multi-function product 1 includes a CPU 11, a ROM 14 12, an EEPROM 13, a RAM 14, an image memory 15, a line I/F unit 19, a modem 20, a buffer 21, a scanner 22, an encoder 23, a decoder 24, a printer 25, an operation panel 8, an LCD (liquid crystal display panel) 9, an amplifier 27, a communication handset 47, and the like, which are connected to one another through bus lines 30.

The CPU 11 controls the above-mentioned units connected to one another through the bus lines 30. For example, the CPU 11 performs a process of transmitting/receiving a voice or image data through the line I/F unit 19.

The ROM 12 is a storage unit that is not rewritable and stores a control program executed in the multi-function product 1 and, and a program causing the CPU 11 to execute a process to be described later is stored in the ROM 12. In addition, a handset sound parameter table 12a (will be described in detail later) is also stored in the ROM 12.

The EEPROM 13 is a non-volatile storage unit that is rewritable and can hold recorded data after the power of the multi-function product 1 is turned off.

The RAM 14 is a storage unit that is readable and rewritable and stores various data and history of incoming signals at the time of performing each operation of the multi-function product 1, and a handset sound parameter 14a and a peak voice level 14b, which are recorded and updated in processes to be described later, is stored in the RAM 14.

The image memory 15 is a storage unit that stores image data and bit images for print and is composed of a dynamic RAM (DRAM), which is a cheap and large-capacity memory. In addition, received image data is stored in the image memory 15 and is then printed out on a recording sheet by the printer 25. Then the received image data is removed from the image memory 15. In addition, image data read by the scanner 22 is also stored in the image memory 15.

The line I/F unit 19 controls a line. That is, the line I/F unit 19 receives various signals, such as a ring signal transmitted through a phone line (for example, a switchboard or an IP-phone adaptor) or a signal indicating caller number information (CallerID) such as a phone number of another end user's apparatus, and transmits a dial signal, which is obtained by operating keys on the operation panel 8, to the phone line.

The modem 20 modulates and demodulates image information and communication data and then transmits the image information and communication data, and transmits/receives various sequence signals for controlling the transmission.

The buffer 21 temporarily stores data including encoded image information transmitted/received between the multi-function product 1 and another end user's apparatus.

The scanner 22 reads out a document, which is inserted through a document insertion inlet, as image data and includes a document-conveying motor.

The encoder 23 encodes the image data read out by the scanner 22.

The decoder 24 reads out the image data stored in the buffer 21 or the image memory 15 and then decodes the read image data, and the decoded data is printed out on a recording sheet by the printer 25.

The printer 25 is a known inkjet-type printer including a recording sheet conveying motor that conveys recording sheets, a carriage motor that moves a carriage mounted with a printing head, and a printing head through which ink is ejected on the recording sheet.

The LCD 9 displays various information, such as characters or images, on the basis of instruction signals output from the CPU 11, such that a user can see the information. For example, the various information includes information that FAX data is being transmitted/received or information of a caller, such as a phone number or a facsimile number of the caller or a caller's name or title.

The amplifier 27 serves to output a call sound or a voice through a speaker 28 connected to the amplifier 27.

The handset 47 is a communication transmitter-receiver unit in which a speaker that reproduces a voice signal transmitted from a remote communication apparatus and a microphone through which a voice from a user is input are integrally formed.

A hook switch 48 is turned on when an operation (hook up) of lifting the handset 47 up is performed, and the hook switch 48 is turned off when an operation (hook down) of returning the handset 47 to an original location is performed. The ON/OFF of the hook switch 48 is monitored by the CPU 11. By the CPU 11, a line is connected when the hook switch 48 is turned on and the line is disconnected when the hook switch 48 is turned off. In addition, the ON/OFF of the hook switch 48 can be switched by operating the operation panel 8. When the operation panel 8 is used, it is possible to switch a state of the multi-function product 1 in the same manner as the hook up/down is performed even though the operation (hook up) of lifting the handset 47 is performed.

[Handset Sound Parameter Table/2005-148631]

First, a handset sound parameter table 12a stored in a ROM 12 will be described.

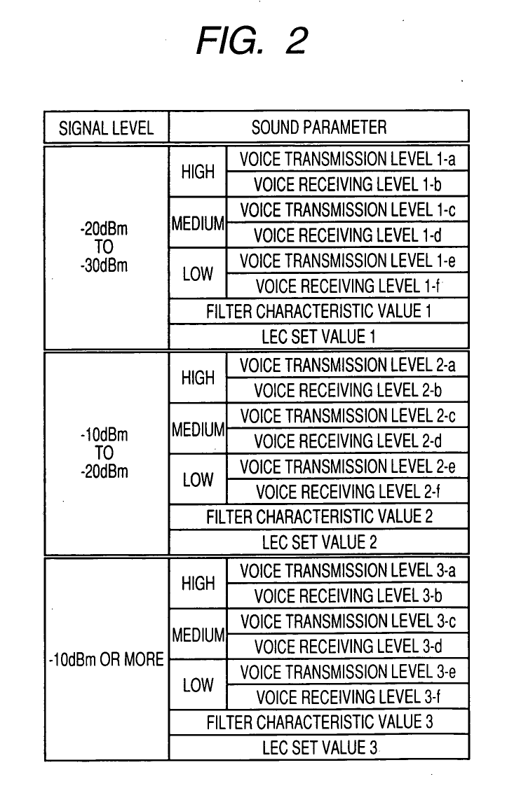

In the present aspect, the handset sound parameter table 12a has a data structure shown in FIG. 2. That is, in the present aspect, three sets of sound parameter groups are stored in the handset sound parameter table 12a, and these three sets of sound parameter groups correspond in one-to-one manner to signal levels (sound levels) of voice signals divided into three ranges (−20 dBm to −30 dBm, −10 dBm to −20 dBm, −10 dBm or more), respectively.

Each set of the sound parameter groups includes four kinds of sound parameters, such as a voice transmission level, a voice receiving level, a filter characteristic value, and an LEC (line echo canceller) set value. For two kinds of sound parameters, which are the voice transmission level and the voice receiving level, among the four kinds of sound parameters, three pairs of sound parameters respectively corresponding to three kinds of sound volume settings (high, medium, low) that can be set through an operation panel 4 are stored.

Among the three sets of sound parameter groups, the sound parameter group corresponding to the range of −20 dBm˜−30 dBm includes parameters for performing a signal processing with respect to a relatively low voice. On the basis of the sound parameter group, a signal processing is performed such that a voice volume is increased, a noise component is removed, and an echo cancellation is performed, for example. As a result, the relatively low voice is converted to a clearly audible voice.

Further, the sound parameter group corresponding to the range of −10 dBm˜−20 dBm includes parameters for performing a signal processing with respect to a standard voice. On the basis of the sound parameter group, a signal processing is performed such that a noise component is removed and an echo cancellation is performed without increasing a voice volume, for example. As a result, the standard voice is converted to a more clearly audible voice.

Furthermore, the sound parameter group corresponding to the range of −10 dBm or more includes parameters for performing a signal processing with respect to a relatively high voice. On the basis of the sound parameter group, a signal processing is performed such that a voice volume is decreased, a noise component is removed, and an echo cancellation is performed, for example. As a result, the relatively high voice is converted to a clearly audible voice.

One of the three sets of sound parameters is selected in a process to be described later, such that a signal processing with respect to the voice signals transmitted between the multi-function product and the remote communication apparatus is performed. At this time, for two kinds of sound parameters which are the voice transmission level and the voice receiving level, one of the three pairs of sound parameters prepared corresponding to the sound volume settings (high, medium, low) is used in response to a sound volume setting (high, medium, low) set through the operation panel 4.

In a subsequent process to be described below, a CPU 11 measures a peak value of a signal level of a voice signal transmitted from the remote communication apparatus, and if a predetermined updating condition (details will be described later) is satisfied, the measured peak value is stored in a peak voice level 14b. In addition, if the peak value stored in the peak voice level 14b is updated, four kinds of sound parameters among one set of the sound parameter group corresponding to the peak value are read out in consideration of the sound volume setting (high, medium, low) set through the operation panel 4, and the four kinds of sound parameters that have been read out are stored in a handset sound parameter 14a.

The CPU 11 is constructed such that a signal processing with respect to a voice signal transmitted between the multi-function product and the remote communication apparatus is performed by always referring to the handset sound parameter 14a. Accordingly, if the peak value stored in the peak voice level 14b is updated, the handset sound parameter is also updated. As a result, the CPU 11 performs a signal processing, which is determined according to the updated peak value, with respect to a voice signal transmitted between the multi-function product and the remote communication apparatus.

[Signal Processing with Respect to Voice Signals]

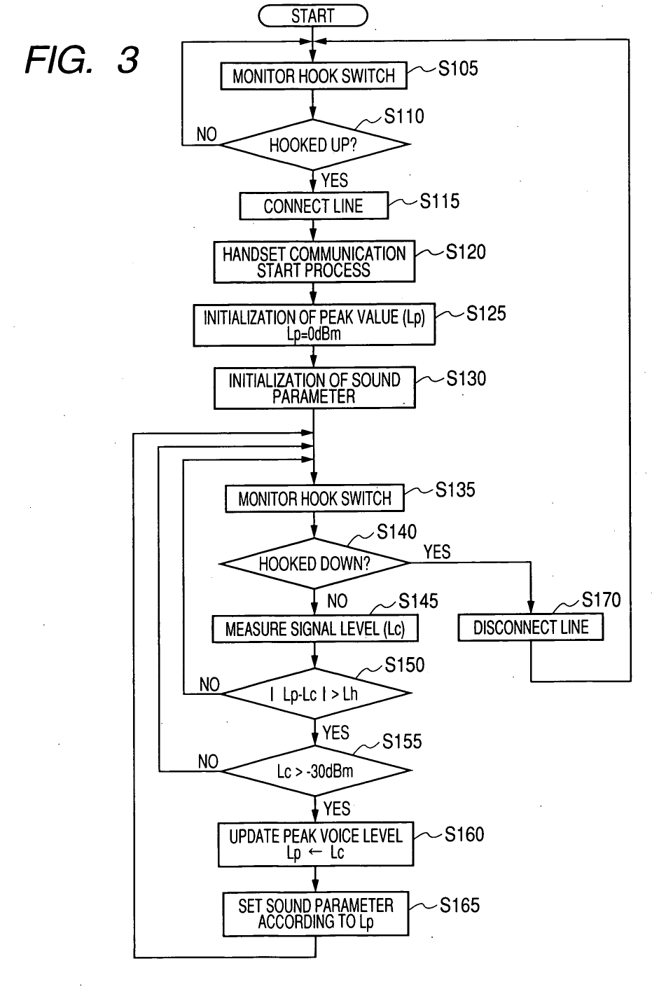

Next, a signal processing with respect to voice signals will be described with reference to a flow chart shown in FIG. 3. The flow chart shown in FIG. 3 illustrates processes related to the aspect of the invention, among processes normally performed by the CPU 11. Even though the CPU 11 performs other processes not shown in FIG. 3, the processes not related to the aspect of the invention are not shown.

First, when a process is started by the CPU 11, a hook switch 48 is monitored (SLOS) and it is determined whether or not a user has hooked up the handset 47 (S110). Here, if the user has not hooked up the handset 47 (S110: NO), the process returns to step S105 and then the processes in steps S105 to S110 are repeated and the monitoring on the hook switch 48 is continued. Further, in step S110, in a case in which a user actually hooks up the handset 47 and even in a case in which the multi-function product 1 switches to a state equal to a case in which the handset 47 is actually hooked up by operating the operation panel 4, it is determined that the handset 47 has been hooked up.

Then, if the user hooks up the handset 47 while steps S105 to S110 are repeated (S110: YES), a communication start process due to the handset 47 is performed (S120), and thus the user can communicate with the other party who uses the remote communication apparatus.

Subsequently, a peak value Lp is initialized (S125). The peak value Lp is a value stored in the peak voice level 14b of the RAM 14. In a process to be described below, after the signal level (voice volume level) of the voice signal transmitted between the multi-function product and the remote communication apparatus is measured, a peak value of the measured signal level is stored. In step S125, since the signal level of the voice signal transmitted between the multi-function product and the remote communication apparatus is not measured, 0 dBm is stored as an initial value in the peak voice level 14b of the RAM 14.

Thereafter, the handset sound parameter is initialized (S130). In step S130, a sound parameter group corresponding to the initial value (0 dBm) of the peak value (Lp) is read out from the handset sound parameter table 12a of the ROM 12. At this time, the sound volume setting (high, medium, low) set through the operation panel 4 is referred, and the two kinds of sound parameters (a voice transmission level and a voice receiving level) according to the sound volume setting and the other two kinds of sound parameters (a filter characteristic value and an LEC set value) are read out. In addition, the four kinds of sound parameters that have been readout are stored in the handset sound parameter 14a of the RAM 14. As already described above, since the CPU 11 performs a signal processing with respect to a voice signal transmitted between the multi-function product and the remote communication apparatus by always referring to the handset sound parameter 14a, the signal processing is performed assuming that the peak value of the signal level of the voice signal transmitted between the multi-function product and the remote communication apparatus is 0 dBm at a time when the process in step S130 has been performed.

The reason why the signal processing is performed assuming that the peak value of the signal level of the voice signal is 0 dBm is that it is possible to properly reduce the voice volume when the signal level of the voice signal transmitted between the multi-function product and the remote communication apparatus is relatively high and it is also possible to prevent an unexpected high volume voice from being generated at least through the handset 47 by only reducing the voice volume even when the signal level of the voice signal is relatively low. For example, if a signal processing is performed assuming that the peak value of the signal level of the voice signal transmitted between the multi-function product and the remote communication apparatus is −30 dBm, it may be possible to properly increase the voice volume when the signal level of the voice signal transmitted between the multi-function product and the remote communication apparatus is relatively low; however, when the signal level is relatively high, the voice volume becomes even more increased, and accordingly, there is a possibility that an unexpected high voice will be generated through the handset 47.

Then, the hook switch 48 is monitored (S135) and it is determined whether or not the handset 47 has been hooked down (S140). Here, if it is determined that the handset 47 has not been hooked down (S140: NO), a signal level Lc of the voice signal transmitted between the multi-function product and the remote communication apparatus (S145) is measured.

Thereafter, it is determined whether or not an absolute value |Lp−Lc| of a difference between the peak value Lp stored in the peak voice level 14b of the RAM 14 and the signal level Lc measured in step S145 is larger than a predetermined threshold value Lh (in the present aspect, 5 dBm) (S150). If |Lp−Lc|>Lh (S150: YES), it is determined whether or not the signal level Lc measured in step S145 is larger than −30 dBm (S155).

Here, if Lc>−30 dBm (S155: YES), the peak voice level is updated (S160). Specifically, the peak value Lp is updated by storing the signal level Lc measured in step S145 in the peak voice level 14b of the RAM 14. Then, handset sound parameter according to the new peak value Lp is set (S165). In step S165, four kinds of sound parameters (a voice transmission level, a voice receiving level, a filter characteristic value, and an LEC set value) corresponding to the new peak value Lp are read out from the handset sound parameter table 12a of the ROM 12, and the read sound parameter group is stored in the handset sound parameter 14a of the RAM 14. Then, since the CPU 11 performs a signal processing by referring to the handset sound parameter 14a, a signal processing based on the new sound parameter group is performed with respect to the voice signal transmitted between the multi-function product and the remote communication apparatus. After the process in step S165 is completed, the process returns to step S135.

On the other hand, in step S150, if |Lp−Lc|≦Lh (S150: NO), the process returns to step S135 without performing the processes in steps S160 and 165. Thus, it is possible to prevent the sound parameter group from being frequently updated too many times when the signal level Lc measured in step S145 fluctuates around boundary values (in the present aspect, −10 dBm and −20 dBm) of the three signal level ranges corresponding to the three sets of sound parameter groups. Specifically, for example, when the signal level Lc measured in step S145 fluctuates within a range of −9 dBm˜−11 dbm with a boundary value of −10 dBm interposed therebetween, the sound parameter group is frequently updated too many times if the process in step S150 is not performed. As a result, the decrease of the voice volume or the stopping of the decrease of the voice volume may be repeated frequently. However, since the sound parameter group is not updated due to the process in step S150, the decrease of the voice volume or the stopping of the decrease of the voice volume is not repeated frequently.

Further, in step S155, even in a case of Lc<−30 dBm (S155: NO), the process returns to step S135 without performing the processes in steps S160 and 165. Thus, the signal level Lc measured in step S145 becomes in a temporarily silent state or a state close to the silent state. As a result, it is possible to prevent unnecessary voice volume from increasing due to the update of the sound parameter group.

As such, if a negative determination is made in step S150, if a negative determination is made in step S155, or if the process in step S165 is completed, the process returns to step S135. Then, as long as it is determined that the handset 47 has not been hooked down in step S140 (S140), the processes in steps S135 to S165 are repeated. That is, during the communication, the processes in steps S135 to S165 are repeated. Further, while the processes in steps S135 to S165 are repeated, if it is determined that the absolute value |Lp−Lc| of the difference between the peak value Lp stored in the peak voice level 14b of the RAM 14 and the signal level Lc measured in step S145 is larger than the predetermined threshold value Lh (S150: YES) and the signal level Lc measured in step S145 is larger than −30 dBm (S155: YES), the sound parameter group is updated. Then, a process of optimizing the voice volume, a process of removing a noise component in correspondence with the voice volume, or an echo cancellation is performed, such that the voice signal transmitted between the multi-function product and the remote communication apparatus is converted to a clearly audible voice.

In addition, if it is determined that the handset 47 has been hooked down in step S140 while the processes in steps S135 to S165 are repeated (S140: YES), the line is disconnected (S170) and then the process returns to step S105. Then, until it is determined that the handset 47 has been hooked up again, the processes in steps S105 and S110 are repeated.

In the present aspect described above, the CPU 11 that performs the process in step S145 corresponds to a measurement unit of the invention, and the CPU 11 that performs the signal processing with respect to the voice signal transmitted between the multi-function product and the remote communication apparatus by referring to the sound parameter groups stored in the handset sound parameter 14a of the RAM 14 corresponds to a signal processing unit of the invention. In addition, the RAM 14 (peak voice level 14b) in which the signal level is stored by the process in step S160 corresponds to a peak value storage unit of the invention, the CPU 11 that performs the processes in steps S150 and S155 corresponds to a determination unit of the invention, and the CPU 11 that performs the process in step S160 corresponds to an updating unit of the invention.

While the invention has been described with reference to the above-mentioned aspects, the invention can be implemented in different forms without being limited to the above-mentioned aspect.

For example, in the aspect described above, even though the case in which the voice processing device of the invention is applied to the multi-function product 1 has been described, the voice processing device of the invention can be applied to communication apparatus other than the multi-function product. Specifically, the configuration of the invention can also be applied to a single-function phone, which does not have a facsimile function or the like. In addition, the configuration of the invention can be applied to any one of a phone connected to an IP network (a so-called IP phone), a mobile phone, and the like, as well as a typical phone connected to a PSTN network. In addition, when a microphone or a headphone is connected to a personal computer and IP phone software is installed in the personal computer at the same time, an IP communication becomes possible by using the personal computer. Even in this case, the configuration of the invention can also be applied to an IP communication apparatus constructed by using the personal computer.

Further, in the present aspect, even though the signal levels of the voice signals are divided into the three ranges and the three sets of sound parameter groups corresponding to each of the ranges are stored in the handset sound parameter table 12a, the signal levels of the voice signals may not be necessarily divided into the three ranges. For example, the signal levels of the voice signals may be divided into two ranges or four ranges or more. In addition, the boundary values of each range are not limited to −10 dBm and −20 dBm, but may be arbitrarily changed. In addition, even though one set of a sound parameter group includes the four kinds of sound parameters, the number of sound parameters is not limited thereto.

Furthermore, in the present aspect, even though a sound parameter group is read out from the handset sound parameter table 12a, a method of obtaining the sound parameter group is not limited to the table reference method. For example, by using a predetermined equation f (x) having a signal level x of a voice signal as a variable, a predetermined sound parameter y=f(x) can be calculated.

Furthermore, in the present aspect, even though the threshold value Lh is set to 5 dBm in step S150, the threshold value Lh may be set to values other than 5 dBm. In addition, even though it is determined whether or not the signal level Lc is larger than −30 dBm in step S155, values other than −30 dBm may be set.

Further, there are two kinds of voice signals transmitted between the multi-function product and the remote communication apparatus, that is, a voice signal transmitted to the remote communication apparatus and a voice signal transmitted from the remote communication apparatus. Here, it is most effective to apply the invention to both the voice signals. However, even though the invention is applied for one of the voice signals, the same effects can be obtained. That is, the invention may be applied for both a voice transmitter and a voice receiver, or for only the voice transmitter, or for only the voice receiver. For example, in the case when the invention is applied for the voice transmitter, even if a voice made by a user of a communication apparatus is too small or too large, the voice can be corrected to have a proper voice volume or a proper voice quality and then the corrected voice can be transmitted to the remote communication apparatus. In addition, in the case when the invention is applied for the voice receiver, even if a voice transmitted from the remote communication apparatus is too small or too large, the voice can also be corrected to have a proper voice volume or a proper voice quality and thus the user of the communication apparatus can listen to the corrected voice.

As was described, according to the aspect of the invention, as the signal processing performed by the signal processing unit, several specific processes may be considered. For example, preferably, the signal processing unit performs at least one of a process of changing the voice volume level to a level determined according to the peak value and a process of changing a level of an echo cancellation to a level determined according to the peak value with respect to the voice signal transmitted from/to the remote communication apparatus.

By changing the voice volume level to a level determined according to the peak value, for example, by decreasing the voice volume in a case of a high peak value or increasing the voice volume in a case of a low peak value, the voice can be converted to a clearly audible voice.

In addition, in the echo cancellation process, since the echo (returning voice of a person in communication) tends to increase as the peak value increases, the level (setting) of the echo cancellation is changed such that the echo cancellation is more effective in the case of a high peak value and the echo cancellation is less effective in the case of a low peak value. Thus, the voice can be converted to a clearly audible voice. Specifically, if the echo is excessively large, it tends to be difficult to understand the voice of the other party in communication; however, removing the echo completely does not necessarily provide a clearly audible communication condition. That is, even though it is not desirable that the effect of the echo cancellation is too weak, it is not desirable either that the effect of the echo cancellation is too strong. Accordingly, as described above, by changing the level of the echo cancellation according to the peak value, it is possible to prevent even the echo from becoming excessively large when the voice volume is high and to prevent the echo from becoming excessively small when the voice volume is low.

It is more effective to perform both the process of changing the voice volume level and the echo cancellation process, even though certain effects can be obtained when only one of them is performed.

Further, if it is determined that the peak value of the voice level measured by the measurement unit has been varied, the signal processing unit may perform a signal processing, which is determined according to the peak value, as soon as the peak value is varied. However, if the peak value frequently varies, the signal processing is frequently performed, which causes distortion in hearing.

Therefore, in order to avoid the distortion in hearing, preferably, the voice processing device further includes: a peak value storage unit that stores the peak value; a determination unit that determines whether or not the peak value stored in the peak value storage unit is updated on the basis of the peak value stored in the peak value storage unit and the peak value measured by the measurement unit; and an updating unit that updates the peak value stored in the peak value storage unit to the peak value measured by the measurement unit when the determination unit determines that the peak value has been updated. In addition, preferably, the signal processing unit performs the signal processing with respect to the voice signal transmitted from/to the remote communication apparatus on the basis of the peak value stored in the peak value storage unit.

According to the voice processing device, the updating unit updates the peak value stored in the peak value storage unit only when the determination unit determines that the peak value has been updated, even though the peak value of the voice level measured by the measurement unit has varied. Thus, by properly setting determination conditions in consideration of the variation of the peak value, it is possible to suppress the signal processing from being frequently performed when the peak value frequently varies. As a result, it is possible to prevent distortion in hearing.

For the determination conditions used in the determination unit, several conditions may be considered. For example, preferably, the determination unit determines that the peak value stored in the peak value storage unit is to be updated when a difference between the peak value stored in the peak value storage unit and the peak value of the voice volume level measured by the measurement unit is equal to or larger than a predetermined value.

In this case, since the signal processing performed by the signal processing unit is not changed when the peak value varies slightly, it is possible to prevent distortion in hearing.

Further, preferably, the determination unit determines that the peak value stored in the peak value storage unit is to be updated when the peak value of the voice volume level measured by the measurement unit is larger than a predetermined lowermost value.

In this case, since the signal processing performed by the signal processing unit is not changed when the peak value becomes extremely low, the voice volume is not increased according to an instant no-sound. As a result, it is possible to prevent distortion in hearing.

Furthermore, the voice processing device described above can be effectively applied to a communication apparatus, such as a typical phone or an IP phone device constructed by using a personal computer or the like.

In addition, when using a program product that causes a computer included in a phone or a personal computer to function as each of the units included in the voice processing device described above, it is possible to construct the voice processing device by means of the computer.

Now, a second aspect of the invention will be described. Incidentally, like or equivalent portions are designated by the same reference numerals as the first aspect.

[Schematic Configuration of an Overall Communication System]

First, a schematic configuration of an overall communication system will be described.

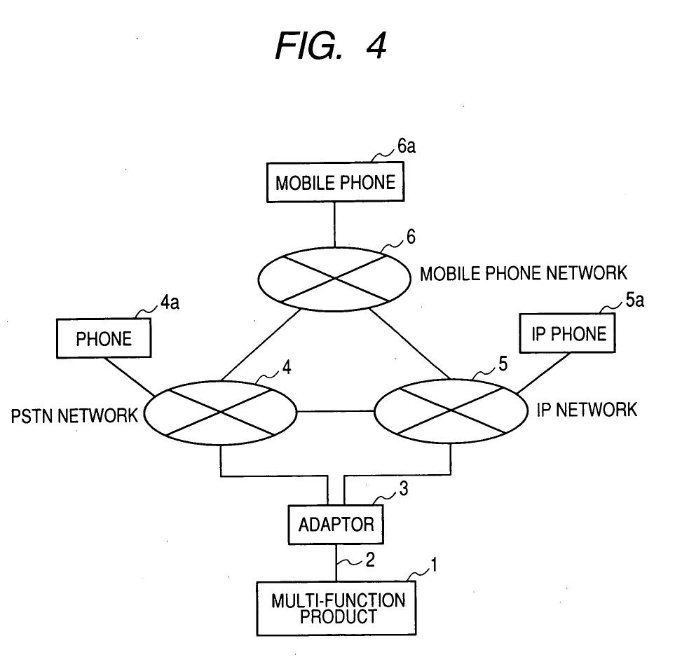

As shown in FIG. 4, a multi-function product 1 is connected to an adaptor 3 through a single communication line 2 and can use both a PSTN network 4 and an IP network 5 through the adaptor 3. That is, the multi-function product 1 can use the PSTN network 4 and the IP network 5 as a communication network.

Further, the PSTN network 4 and the IP network 5 are interconnected to each other through a gateway, and each of the PSTN network 4 and the IP network 5 is also interconnected to a mobile phone network 6 through a gateway. A phone 4a, an IP phone 5a, and a mobile phone 6a are connected to the PSTN network 4, the IP network 5, and the mobile phone network 6, respectively. Each of the phone 4a, the IP phone 5a, and the mobile phone 6a corresponds to a remote communication apparatus, as seen from a side of the multi-function product 1. If the remote communication apparatus is the phone 4a, a communication network used by the remote communication apparatus is the PSTN network 4, if the remote communication apparatus is the IP phone 5a, a communication network used by the remote communication apparatus is the IP network 5, and if the remote communication apparatus is the mobile phone 6a, a communication network used by the remote communication apparatus is the mobile phone network 6.

The adaptor 3 is sold as various names, such as an ADSL modem corresponding to an IP phone, a broadband router corresponding to an IP phone, or a VoIP adaptor, according to the functional difference or the difference of a connection type between the adaptor 3 and the IP network 5. All of the devices described above are relay devices each having a function through which a general phone (the multi-function product 1 in the present aspect) can be used as an IP phone.

When a signal is transmitted from the multi-function product 1 to a remote communication apparatus, the adaptor 3 determines whether to use both the PSTN network 4 and the IP network 5 on the basis of a phone number transmitted from the multi-function product 1 and then connects the communication network, which is determined to be used, with the multi-function product 1.

Further, when a signal is transmitted to the multi-function product 1, the adaptor 3 connects the communication network, through which the signal has been transmitted, with the multi-function product 1. At this time, the adaptor 3 transmits a ring signal to the multi-function product 1 in order to notify the multi-function product 1 that there is an incoming signal. A signal pattern of the ring signal in the case in which the incoming signal has been transmitted through the PSTN network 4 is different from a signal pattern of the ring signal in the case in which the incoming signal has been transmitted through the IP network 5, and the multi-function product 1 determines whether the incoming signal has been transmitted through the PSTN network 4 or the IP network 5 on the basis of the signal pattern of the ring signal transmitted from the adaptor 3.

[Configuration of a Multi-Function Product]

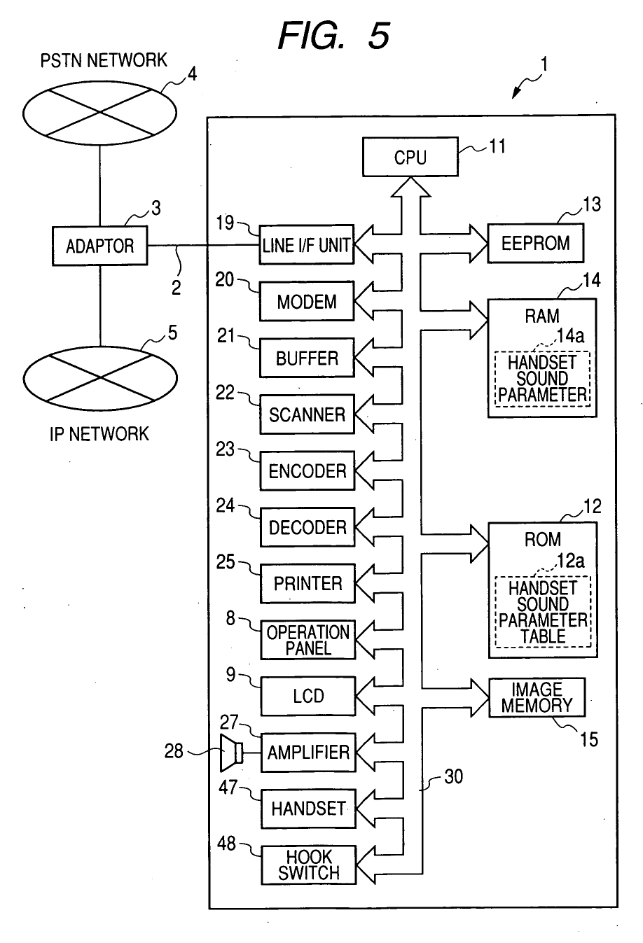

As shown in FIG. 5, the multi-function product 1 includes a CPU 11, a ROM 14 12, an EEPROM 13, a RAM 14, an image memory 15, a line I/F unit 19, a modem 20, a buffer 21, a scanner 22, an encoder 23, a decoder 24, a printer 25, an operation panel 8, an LCD (liquid crystal display panel) 9, an amplifier 27, a communication handset 47, and the like, which are connected to one another through bus lines 30.

[Handset Sound Parameter Table]

Next, the handset sound parameter table 12a stored in the ROM 12 will be described.

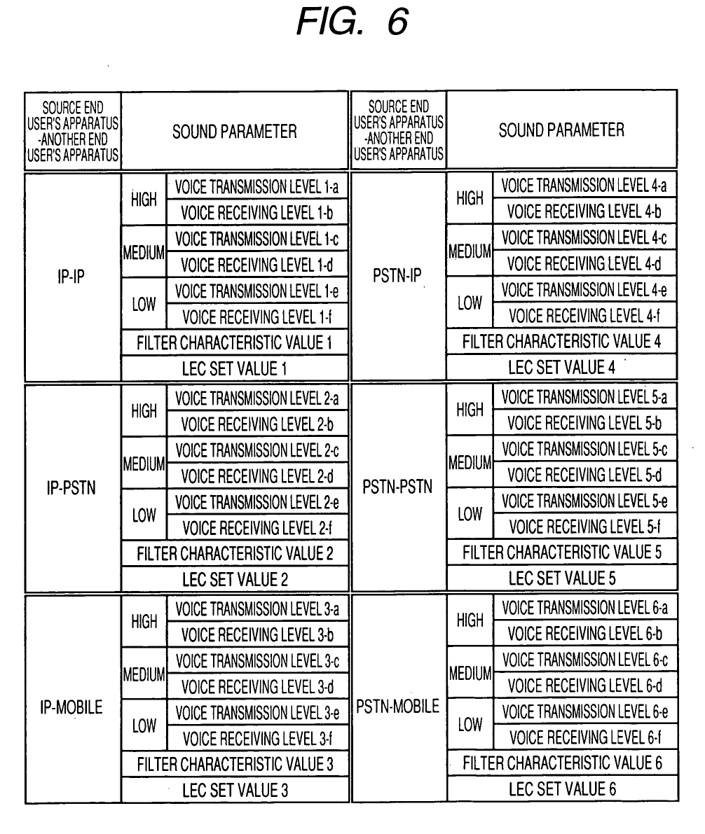

In the present aspect, the handset sound parameter table 12a has a data structure shown in FIG. 6. That is, in the present aspect, six sets of sound parameter groups are stored in the handset sound parameter table 12a. The six sets of sound parameter groups correspond in an one-to-one manner with respect to combinations (six combinations in total) of two kinds of end user's communication networks (the PSTN network 4 and the IP network 5) and three kinds of another end user communication networks (the PSTN network 4, the IP network 5, and the mobile phone network 6), respectively.

Each set of the sound parameter groups includes four kinds of sound parameters, such as a voice transmission level, a voice receiving level, a filter characteristic value, and an LEC (line echo canceller) set value. For two sound parameters, which are the voice transmission level and the voice receiving level, among the four kinds of sound parameters, three pairs of sound parameters respectively corresponding to three kinds of sound volume settings (high, medium, low) that can beset through the operation panel 8 are stored.

Among the six sets of sound parameters, a sound parameter group, corresponding to a case in which the PSTN network 4 is used for a source end user's apparatus or another end user's apparatus, is parameters that perform a signal processing for compensating attenuation of a voice level. The signal processing is performed on the basis of the sound parameter group so as to increase the voice volume, and thus a relatively low voice is converted to a clearly audible sound.

In addition, a sound parameter group corresponding to a case, in which the IP network 5 is used for the source end user's apparatus or another end user's apparatus, is parameters that perform a signal processing for suppressing echoes from occurring due to an impedance characteristic specific to the IP network 5. The signal processing is performed on the basis of the sound parameter group such that the echoes can be cancelled, and thus a voice is converted into a clearly audible sound.

Moreover, a sound parameter group corresponding to a case, in which the mobile phone network 6 is used for another end user's apparatus, is parameters that perform a signal processing for suppressing, for example, external noises or noises due to wind from occurring. The signal processing is performed on the basis of the sound parameter group such that noise components are cut and a human voice is emphasized, and thus a voice is converted into a clearly audible sound.

One of the six sets of sound parameter groups is selectively used in processes to be described below, and thus a signal processing with respect to a voice signal transmitted between the end user's device and the remote communication apparatus is performed. At this time, for the two sound parameters of the voice transmission level and the voice receiving level, one of the prepared three pairs of sound parameters corresponding to the sound volume setting (high, medium, low) is used according to a sound volume setting (high, medium, low) set by using the operation panel 8.

In processes to be described below, the CPU 11 performs a determination on a source end user communication network and another end user communication network, selects one set of a sound parameter group corresponding to the determination result, reads out four kinds of sound parameters on the basis of the selected one set of the sound parameter group in consideration of the voice volume setting (high, medium, low) set by using the operation panel 8, and stores the four read sound parameters in the handset sound parameter 14a of the RAM 14.

The CPU 11 is constructed such that a signal processing with respect to a voice signal transmitted between the multi-function product 1 and the remote communication apparatus is performed by always referring to the handset sound parameter 14a. Thus, the CPU 11 performs a signal processing, which is determined by a combination of the source end user communication network and another end user communication network, with respect to the voice signal transmitted between the multi-function product 1 and the remote communication apparatus.

[Communication Processing Performed by a Multi-Function Product]

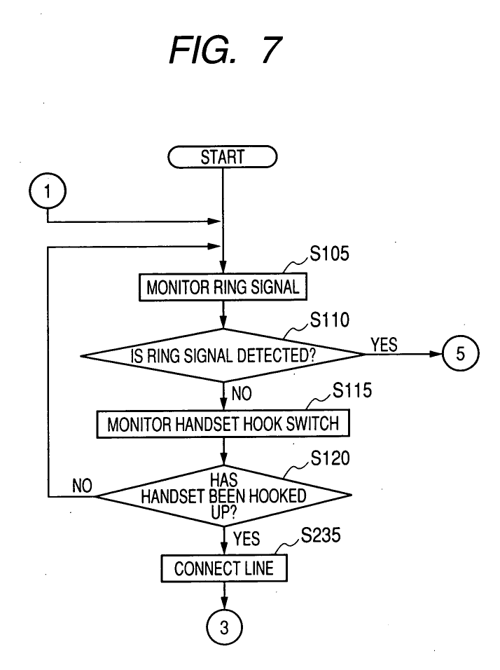

Next, a communication processing performed by the multi-function product 1 will be described with reference to flow charts shown in FIGS. 7 to 12. The flow charts shown in FIGS. 7 to 12 partially illustrate processes among processes normally performed by the CPU 11 in the multi-function product 1. Even though the CPU 11 performs other processes, which are not shown in FIGS. 7 to 12, the processes not related to the aspect of the invention are not shown.

First, as shown in FIG. 7, when a process starts by the CPU 11, a ring signal transmitted from the adaptor 3 is monitored (S105). Here, if there is no ring signal (S110: NO), the handset hook switch 48 is monitored (S115), and if the handset 47 is not hooked up (S120: NO), the process returns to step S105. Thus, while there is no ring signal and the handset 47 is not hooked up, the processes in steps S105 to S120 are repeated, and accordingly, the ring signal and the hook up of the handset 47 are continuously monitored. Further, in step S120, in a case in which a user actually hooks up the handset 47 and even in a case in which the multi-function product 1 switches to a state equal to a case in which the handset 47 is actually hooked up by operating the operation panel 8, it is determined that the handset 47 has been hooked up. The hook-up of the handset 47 is monitored in a subsequent process, and the above description is applied to the subsequent process.

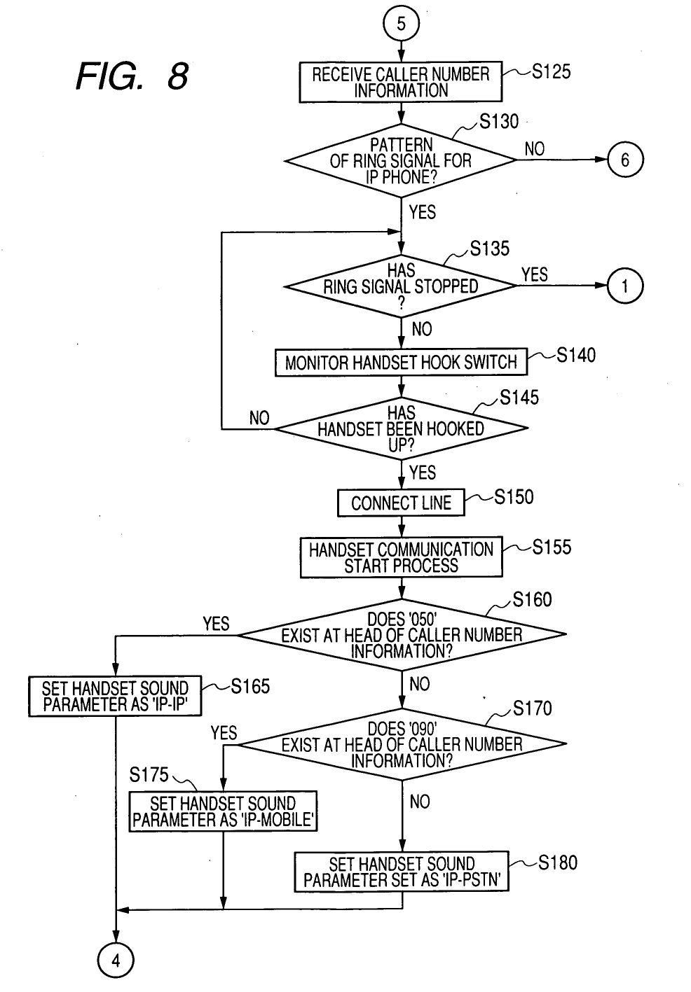

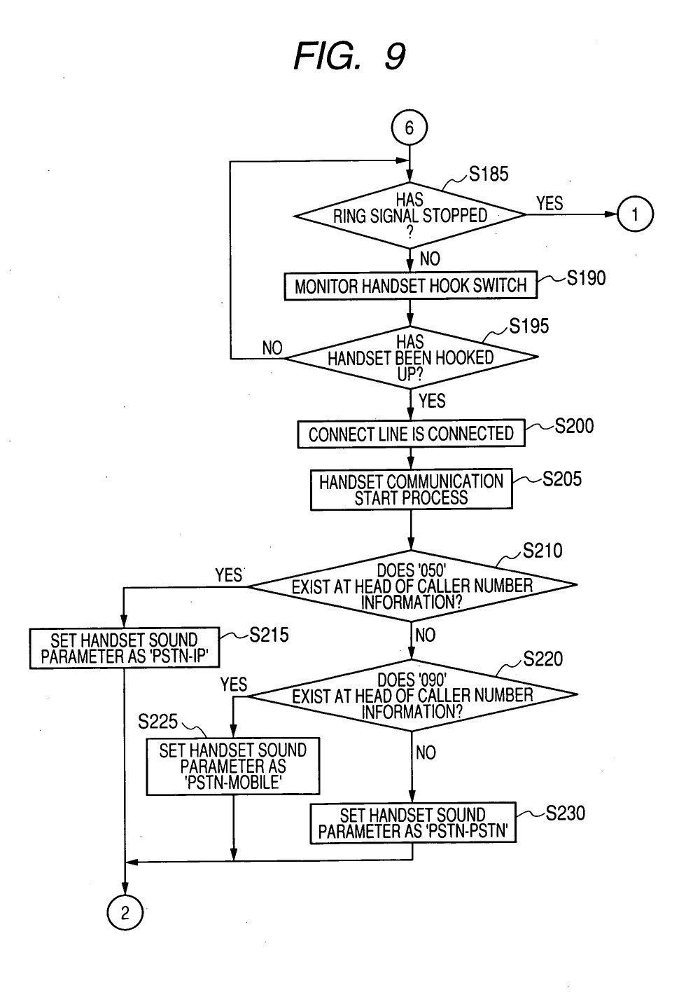

While steps S105 to S115 are repeated, when a ring signal is transmitted from the adaptor 3 in response to an incoming signal transmitted from the remote communication apparatus (S110: YES), the process proceeds to a process performed when the incoming signal is detected, which is shown in FIGS. 8 and 9. In the process performed when the incoming signal is detected, the caller number information transmitted from the remote communication apparatus is received (S125), and then it is determined whether or not the ring signal is a pattern of a ring signal for an IP phone (S130).

Here, when the incoming signal has been transmitted through the IP network 5, the signal pattern of the ring signal becomes a ring signal pattern for the IP phone (S130: YES), and in this case, the process proceeds to processes (refer to FIG. 8) when the incoming signal has been transmitted through the IP network 5, which are shown in steps S135 to S180. In addition, when the incoming signal has been transmitted through the PSTN network 4, the signal pattern of the ring signal does not become a ring signal pattern for the IP phone (S130: NO), and in this case, the process proceeds to processes (refer to FIG. 9) when the incoming signal has been transmitted through the PSTN network 4, which are shown in steps S185 to S230.

When the process proceeds to processes in steps S135 to S180 when the incoming signal has been transmitted through the IP network 5, it is first determined whether or not the ring signal has stopped (S135). If it is determined that the ring signal has not stopped (S135: NO), a monitoring on the handset hook switch 48 is performed (S140), and if the handset 47 has not been hooked up (S145: NO), the process returns to step S135. Thus, while the ring signal does not stop and the handset 47 is not hooked up, steps S135 to S145 are repeated and the monitoring on the hook-up of the handset 47 is continued until the ring signal stops.

Here, when the ring signal has stopped (S135: YES), a called line is disconnected. Therefore, the process returns to step S105 (refer to FIG. 7) so as to repeat steps S105 to S120.

On the other hand, if a user hooks up the handset 47 while steps S135 to S145 are repeated (S145: YES), the line is connected (S150) and then a call start process of the handset 47 is performed (S155).

Thereafter, a setting on handset sound parameters is performed in steps S160 to S180. Here, since a positive determination has been made in step S130 and thus it has been already determined that the source end user communication network is the IP network 5, it is determined that another end user communication network corresponds to which one of the PSTN network 4, the IP network 5, and the mobile phone network 6. According to the determination result, a setting on the handset sound parameters is performed.

Specifically, first, the CPU 11 determines whether or not ‘050’ exists at the head of the caller number information (S160). If the ‘050’ exists at the head of the caller number information (S160: YES), the remote communication apparatus is a device (for example, the IP phone 5a) using the IP network 5, and each of both the source end user communication network and another end user communication network is the IP network 5. Accordingly, in this case, the handset sound parameter is set as ‘IP-IP’ (S165).

In step S165, a sound parameter group corresponding to ‘IP-IP’ is read out from the handset sound parameter table 12a of the ROM 12. At this time, the sound volume setting (high, medium, low) set through the operation panel 8 is referred, and two kinds of sound parameters (voice transmission level and voice receiving level) according to the sound volume setting and the other two kinds of sound parameters (filter characteristic value and LEC set value) are read out. Then, the read four kinds of sound parameters are stored in the handset sound parameter 14a of the RAM 14. As described above, since the CPU 11 performs a signal processing with respect to a voice signal transmitted between the multi-function product 1 and the remote communication apparatus by always referring to the handset sound parameter 14a, a signal processing corresponding to a case in which the source end user communication network is the IP network 5 and another end user communication network is the IP network 5 is performed after the process in step S165 has been performed.

In addition, if ‘050’ does not exist at the head of the caller number information (S160: NO), it is determined whether or not ‘090’ exists at the head of the caller number information (S170). If the ‘090’ exists at the head of the caller number information (S170: YES), the remote communication apparatus is a device (for example, the mobile phone 6a) using the mobile phone network 6, the source end user communication network is the IP network 5, and another end user communication network is the mobile phone network 6. Accordingly, in this case, the handset sound parameter is set as ‘IP-mobile’ (S175). In addition, in step S175, a handset sound parameter group corresponding to ‘IP-mobile’ is read out from the handset sound parameter table 12a of the ROM 12, and the other process is the same as the process in step S165. Thereafter, even though the process (for example, steps S180, S215, S225, and S230) of setting the handset sound parameter is not repeatedly explained so as to avoid the explanation from being complicated, the process is almost equal to the process in step S165.

On the other hand, in step S170, when ‘090’ does not exist at the head of the caller number information (S170: NO), the remote communication apparatus is a device (for example, the phone 4a) using the PSTN network 4, the source end user communication network is the IP network 5, and another end user communication network is the PSTN network 4. Accordingly, in this case, the handset sound parameter is set as ‘IP-PSTN’ (S180).

After the setting on handset sound parameters has been performed through steps S160 to S180 described above, the process proceeds to a call process through an IP network, but the call process through the IP network will be described later.

On the other hand, as a result of the determination in step S130, in the case in which the process proceeds to a process when the incoming signal has been transmitted through the PSTN network 4, first, it is determined whether or not the ring signal has stopped (S185). If the ring signal has not stopped (S185: NO), a monitoring on the handset hook switch 48 is performed (S190). If the handset 47 has not been hooked up (S190: NO), the process returns to step S185. Thus, while the ring signal does not stop and the handset 47 is not hooked up, steps S185 to S195 are repeated and the monitoring on the hook-up of the handset 47 is continued until the ring signal stops.

Here, when the ring signal has stopped (S185: YES), a called line is disconnected. Therefore, the process returns to step S105 (refer to FIG. 7) so as to repeat steps S105 to S120.

On the other hand, if a user hooks up the handset 47 while steps S185 to S195 are repeated (S195: YES), the line is connected (S200) and then a call start process of the handset 47 is performed (S205)

Thereafter, a setting on handset sound parameters is performed in steps S210 to S230. Here, since a negative determination has been made in step S130 and thus it has been already determined that the source end user communication network is the PSTN network 4, it is determined that another end user communication network corresponds to which one of the PSTN network 4, the IP network 5, and the mobile phone network 6. According to the determination result, a setting on the handset sound parameters is performed.

Specifically, first, the CPU 11 determines whether or not ‘050’ exists at the head of the caller number information (S210). If ‘050’ exists at the head of the caller number information (S210: YES), the remote communication apparatus is a device (for example, the IP phone 5a) using the IP network 5, and the source end user communication network is the PSTN network 4 and another end user communication network is the IP network 5. Accordingly, in this case, the handset sound parameter is set as ‘PSTN-IP’ (S215).

On the other hand, in step S210, if ‘050’ does not exist at the head of the caller number information (S210: NO), it is determined whether or not ‘090’ exists at the head of the caller number information (S220). If ‘090’ exists at the head of the caller number information (S220: YES), the remote communication apparatus is a device (for example, the mobile phone 6a) using the mobile phone network 6, the source end user communication network is the PSTN network 4, and another end user communication network is the mobile phone network 6. Accordingly, in this case, the handset sound parameter is set as ‘PSTN-mobile’ (S225).

Furthermore, in step S220, when ‘090’ does not exist at the head of the caller number information (S220: NO), the remote communication apparatus is a device (for example, the phone 4a), each of both the source end user communication network and another end user communication network is the PSTN network 4. Accordingly, in this case, the handset sound parameter is set as ‘PSTN-PSTN’ (S230).

After the setting on handset sound parameters has been performed through steps S210 to S230 described above, the process proceeds to a call process through a PSTN network, but the call process through the PSTN network will be described below.

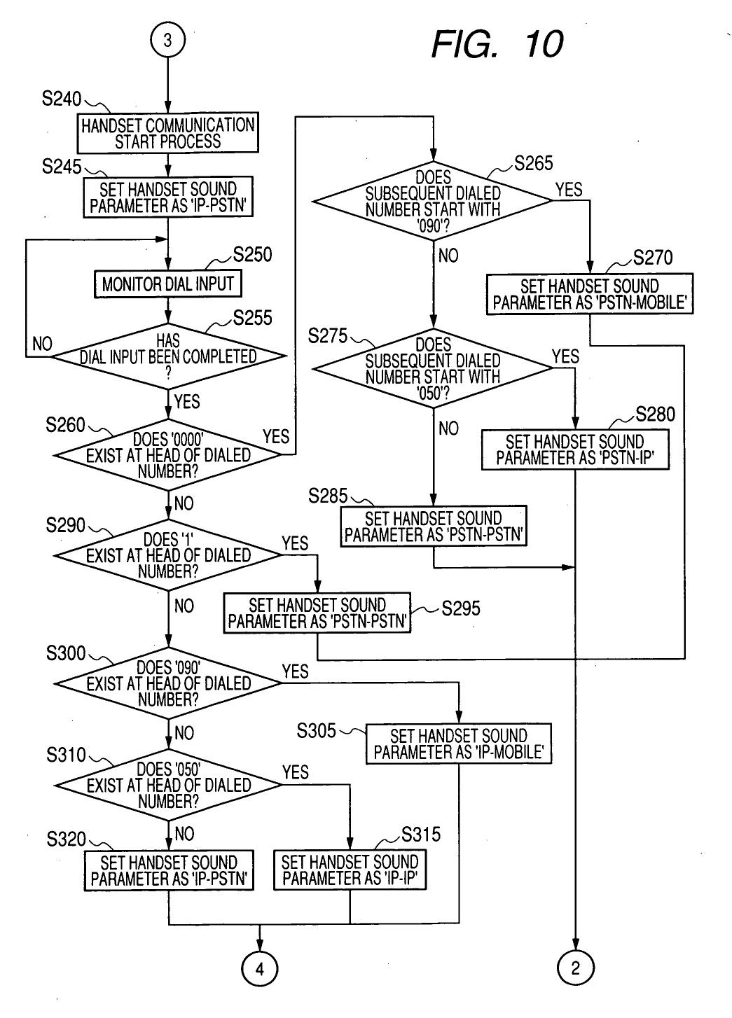

The process when the incoming signal is received has been described with reference to FIGS. 8 and 9. When a user hooks up the handset 47 while steps S105 to 115 are repeated (S120: YES), the line is connected (S235) and the process proceeds to a signal transmission process, which is shown in FIG. 10.

In the signal transmission process, first, a call start process of the handset 47 is performed (S240), and then as an initial value of a handset sound parameter, the handset sound parameter is set as ‘IP-PSTN’ (S245).

Subsequently, monitoring on a dial input is performed (S250), and it is determined whether or not the dial input has been completed (S255). If the dial input has not been completed (S255: NO), the process returns to step S250, and then steps S250 to S255 are repeated while waiting for the dial input. Further, the dial input is input by number buttons on the operation panel 8 or input through a registered list that has been registered beforehand. The determination on whether the dial input has been completed is made on the basis of whether a predetermined number of buttons are pressed on the operation panel 8, whether a call button has been operated, and the input through the registered list has been completed.

When the dial input has been completed (S255), it is determined whether or not ‘0000’ exists at the head of the dialed number (S260). This is a process according to the specifications of the adaptor 3. More specifically, if ‘0000’ exists at the head of the dialed number transmitted from the multi-function product 1 at the time of a call, the adaptor 3 recognizes that the call through the PSTN network 4 has been designated from the multi-function product 1 to the adaptor 3, and then the adaptor 3 connects the line thereto so that the communication through the PSTN network 4 is possible. Accordingly, if ‘0000’ exists at the head of the dialed number at the time of a call, the multi-function product 1 determines that the source end user communication network is the PSTN network 4.

If ‘0000’ exists at the head of the dialed number (S260: YES), it is determined whether or not a subsequent dialed number starts with ‘090’ (S265). When the subsequent dialed number starts with ‘090’ (S265: YES), the remote communication apparatus is a device (for example, the mobile phone 6a) using the mobile phone network 6, the source end user communication network is the PSTN network 4, and another end user communication network is the mobile phone network 6. Accordingly, in this case, the handset sound parameter is set as ‘PSTN-mobile’ (S270).

Further, in step S265, if the subsequent dialed number does not start with ‘090’ (S265: NO), it is determined whether or not a subsequent dialed number starts with ‘050’ (S275). When the subsequent dialed number starts with ‘050’ (S275: YES), the remote communication apparatus is a device (for example, the IP phone 5a) using the IP network 5, the source end user communication network is the PSTN network 4, and another end user communication network is the IP network 5. Accordingly, in this case, the handset sound parameter is set as ‘PSTN-IP’ (S280).

On the other hand, in step S275, if the subsequent dialed number does not start with ‘050’ (S275: NO), the remote communication apparatus is an apparatus (for example, the phone 4a) using the PSTN network 4, the source end user communication network is the PSTN network 4 and another end user communication network is also the PSTN network 4. Accordingly, in this case, the handset sound parameter is set as ‘PSTN-PSTN’ (S285).

In addition, if ‘0000’ does not exist at the head of the dialed number (S260: NO), it is determined whether or not ‘1’ exists at the head of the dialed number (S290). This is also a process according to the specifications of the adaptor 3. When ‘1’ exists at the head of the dialed number transmitted from the multi-function product 1 at the time of the call, the adaptor 3 connects the call to, for example, 110 or 119 and connects the line such that a communication through the PSTN network 4 can be feasible. Accordingly, if ‘1’ exists at the head of the dialed number at the time of the call, the multi-function product 1 determines that the source end user communication network is the PSTN network 4.

When ‘1’ exists at the head of the dialed number (S290: YES), the remote communication apparatus is a device using the PSTN network 4, the source end user communication network is the PSTN network 4, and another end user communication network is also the PSTN network 4. Accordingly, in this case, the handset sound parameter is set as ‘PSTN-PSTN’ (S295).

After the setting on handset sound parameters has been performed through steps S265 to S295 described above, the process proceeds to a call process through a PSTN network, but the call process through the PSTN network will be described below.

On the other hand, if ‘1’ does not exist at the head of the dialed number (S290: NO), it is determined whether ‘090’ exists at the head of the dialed number (S300). When ‘090’ exists at the head of the dialed number (S300: YES), the remote communication apparatus is an apparatus (for example, the mobile phone 6a) using the mobile phone network 6, the source end user communication network is the IP network 5, and another end user communication network is the mobile phone network 6. Accordingly, in this case, the handset sound parameter is set as ‘IP-mobile’ (S305).

In addition, in step S300, if ‘090’ does not exist at the head of the dialed number (S300: NO), it is determined whether or not ‘050’ exists at the head of the dialed number (S310). When ‘050’ exists at the head of the dialed number (S310: YES), the remote communication apparatus is an apparatus (for example, the IP phone 5a) using the IP network 5, the source end user communication network is the IP network 5, and another end user communication network is also the IP network 5. Accordingly, in this case, the handset sound parameter is set as ‘IP-IP’ (S315).

Furthermore, in step S310, if ‘050’ does not exist at the head of the dialed number (S310: NO), the remote communication apparatus is an apparatus (for example, the phone 4a) using the PSTN network 4, the source end user communication network is the IP network 5, and another end user communication network is the PSTN network 4. Accordingly, in this case, the handset sound parameter is set as ‘IP-PSTN’ (S320).

After the setting on handset sound parameters has been performed through steps S300 to S315 described above, the process proceeds to a call process through an IP network, but the call process through the IP network will be described below.

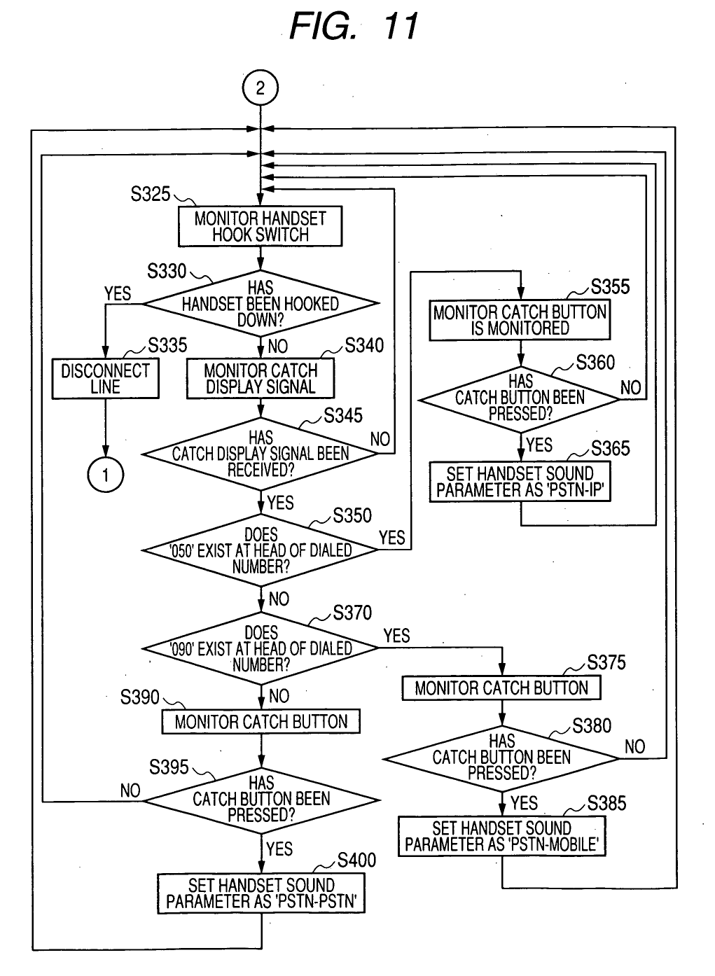

Next, the call process through the PSTN network will be described with reference to FIG. 11.

If the handset sound parameter setting is completed through the processes described above and then the process proceeds to the call process through the PSTN network, a monitoring on the handset hook switch 48 is first performed (S325). If the handset 47 is not hooked down (S330: NO), a catch display signal transmitted from the adaptor 3 is monitored (S340), and if the catch display signal is not received (S345: NO), the process proceeds to step S325. Thus, while the handset 47 is not hooked down and the catch display signal is not received, steps S325 to S345 are repeated and the monitoring on the hook-down of the handset 47 and the catch display signal is continued.

Then, when the handset 47 is hooked down while steps S325 to S345 are repeated (S330: YES), the line is disconnected (S335) and the process returns to step S105 (refer to FIG. 7), such that steps S105 to S120 are repeated.

On the other hand, when the catch display signal is received while steps S325 to S345 are repeated (S345: YES), it is determined whether or not ‘050’ exists at the head of the dialed number (S350). When ‘050’ exists at the head of the dialed number (S350: YES), the remote communication apparatus is an apparatus (for example, the IP phone Sa) using the IP network 5, the source end user communication network is the PSTN network 4, and another end user communication network is the IP network 5. At this time, if the catch display signal is received during the communication, a user can decide whether to change the other party in communication. Accordingly, in this case, a catch button on the operation panel 8 is monitored (S355). If the catch button is pressed (S360: YES), the handset sound parameter is set as ‘PSTN-IP’ (S365) and then the process returns to step S325. On the other hand, if the catch button is not pressed (S360: NO), the process returns to step S325 without performing the process in step S365. Through the processes in step S350 to S365, in the case in which an incoming signal transmitted through the IP network 5 is detected during the communication, the handset sound parameter changes only when the user presses the catch button.

In addition, in step S350, if ‘050’ does not exist at the head of the dialed number (S350: NO), it is determined whether or not ‘090’ exists at the head of the dialed number (S370). If ‘090’ exists at the head of the dialed number (S370: YES), the remote communication apparatus is an apparatus (for example, the mobile phone 6a) using the mobile phone network 6, the source end user communication network is the PSTN network 4, and another end user communication network is the mobile phone network 6. Even in this case, the catch button on the operation panel 8 is monitored (S375). If the catch button is pressed (S380: YES), the handset sound parameter is set as ‘PSTN-mobile’ (S385) and then the process returns to step S325. On the other hand, if the catch button is not pressed (S380: NO), the process returns to step S325 without performing the process in step S385. Through the processes in step S370 to S385, even in the case in which an incoming signal transmitted through the mobile phone network 6 is detected during the communication, the handset sound parameter changes only when the user presses the catch button.

Further, in step S370, if ‘090’ does not exist at the head of the dialed number (S370: NO), the remote communication apparatus is an apparatus (for example, the phone 4a) using the PSTN network 4, the source end user communication network is the PSTN network 4, and another end user communication network is also the PSTN network 4. Even in this case, the catch button on the operation panel 8 is monitored (S390). If the catch button is pressed (S395: YES), the handset sound parameter is set as ‘PSTN-PSTN’ (S400) and then the process returns to step S325. On the other hand, if the catch button is not pressed (S395: NO), the process returns to step S325 without performing the process in step S400. Through the processes in step S370 to S400, even in the case in which an incoming signal transmitted through the PSTN network 4 is detected during the communication, the handset sound parameter changes only when the user presses the catch button.

The processes in steps S325 to S400 described above are the call process through the PSTN network.

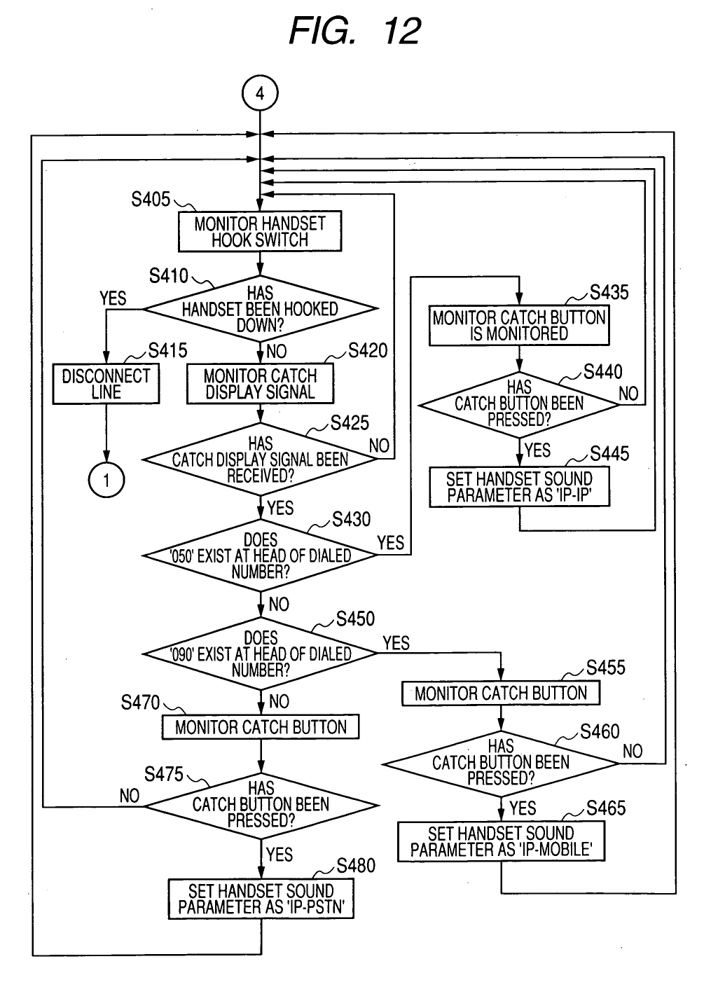

Next, the call process through the IP network will be described with reference to FIG. 12.

If the handset sound parameter setting is completed through the processes described above and then the process proceeds to the call process through the IP network, a monitoring on the handset hook switch 48 is first performed (S405). If the handset 47 is not hooked down (S410: NO), a catch display signal transmitted from the adaptor 3 is monitored (S420), and if the catch display signal is not received (S425: NO), the process proceeds to step S405. Thus, while the handset 47 is not hooked down and the catch display signal is not received, steps S405 to S425 are repeated and the monitoring on the hook-down of the handset 47 and the catch display signal is continued.

Then, when the handset 47 is hooked down while steps S405 to S425 are repeated (S410: YES), the line is disconnected (S415) and the process returns to step S105 (refer to FIG. 7), such that steps S105 to S120 are repeated.

On the other hand, when the catch display signal is received while steps S405 to S425 are repeated (S425: YES), it is determined whether or not ‘050’ exists at the head of the dialed number (S430). When ‘050’ exists at the head of the dialed number (S430: YES), the remote communication apparatus is a device (for example, the IP phone 5a) using the IP network 5, the source end user communication network is the IP network 5, and another end user communication network is also the IP network 5. At this time, as described before, if the catch display signal is received during the communication, a user can decide whether to change the other party in communication. Accordingly, in this case, the catch button on the operation panel 8 is monitored (S435). If the catch button is pressed (S440: YES), the handset sound parameter is set as ‘IP-IP’ (S445) and then the process returns to step S405. On the other hand, if the catch button is not pressed (S440: NO), the process returns to step S405 without performing the process in step S445. Through the processes in step S430 to S445, in the case in which an incoming signal transmitted through the IP network 5 is detected during the communication, the handset sound parameter changes only when the user presses the catch button.

In addition, in step S430, if ‘050’ does not exist at the head of the dialed number (S430: NO), it is determined whether or not ‘090’ exists at the head of the dialed number (S450). If ‘090’ exists at the head of the dialed number (S450: YES), the remote communication apparatus is a device (for example, the mobile phone 6a) using the mobile phone network 6, the source end user communication network is the IP network 5, and another end user communication network is the mobile phone network 6. Even in this case, the catch button on the operation panel 8 is monitored (S455). If the catch button is pressed (S460: YES), the handset sound parameter is set as ‘IP-mobile’ (S465) and then the process returns to step S405. On the other hand, if the catch button is not pressed (S460: NO), the process returns to step S405 without performing the process in step S465. Through the processes in step S450 to S465, even in the case in which an incoming signal transmitted through the mobile phone network 6 is detected during the communication, the handset sound parameter changes only when the user presses the catch button.

Further, in step S450, if ‘090’ does not exist at the head of the dialed number (S450: NO), the remote communication apparatus is a device (for example, the phone 4a) using the PSTN network 4, the source end user communication network is the IP network 5, and another end user communication network is the PSTN network 4. Even in this case, the catch button on the operation panel 8 is monitored (S470). If the catch button is pressed (S475: YES), the handset sound parameter is set as ‘IP-PSTN’ (S480) and then the process returns to step S405. On the other hand, if the catch button is not pressed (S475: NO), the process returns to step S405 without performing the process in step S480. Through the processes in step S350 to S480, even in the case in which an incoming signal transmitted through the PSTN network 4 is detected during the communication, the handset sound parameter changes only when the user presses the catch button.

The processes in steps S405 to S480 described above are the call process through the IP network.

[Communication Relay Process by Adaptor]

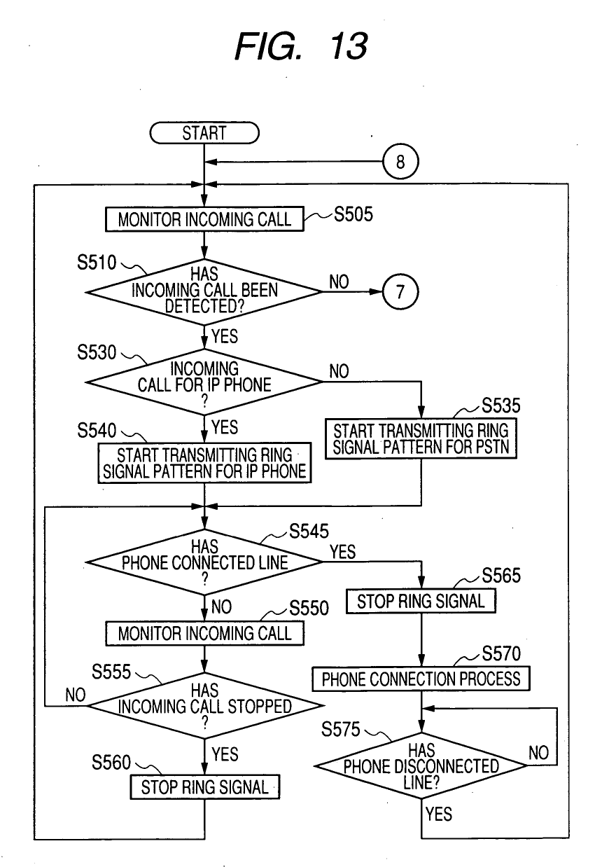

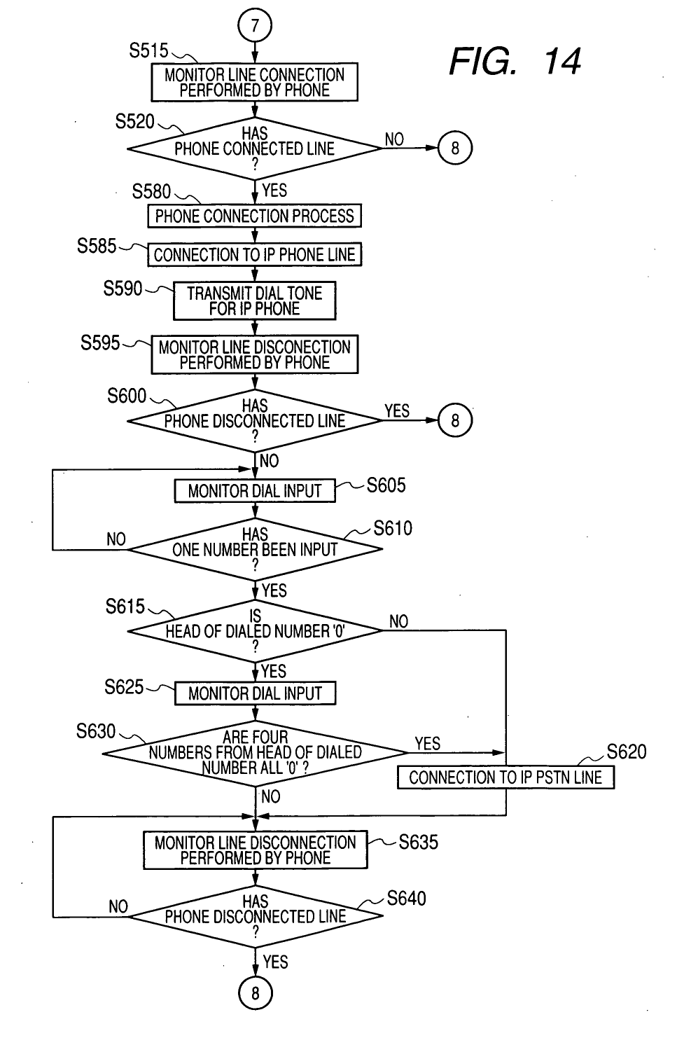

Next, a communication relay process performed by the adaptor 3 will be described with reference to flow charts shown in FIGS. 13 and 14. In addition, the flow charts shown in FIGS. 13 and 14 illustrate processes related to the aspect of the invention, among processes normally performed by the adaptor 3. Even though the adaptor 3 performs other processes, which are not shown in FIGS. 13 and 14, the processes not related to the aspect of the invention are not shown.

First, as shown in FIG. 13, when a process starts by the adaptor 3, an incoming call transmitted through the PSTN network 4 and the IP network 5 is monitored (S505). If there is no incoming call transmitted through the PSTN network 4 and the IP network 5 (S505: NO), a line connection performed by the phone (in the present aspect, the multi-function product 1) is monitored (S515), and if the phone does not connect the line thereto (S520: NO), the process returns to step S505. Thus, while there is no incoming call and the phone does not connect the line thereto, the processes in steps S505 to S520 are repeated, such that the monitoring on the incoming call and the monitoring on the line connection performed by the phone are continuously performed.

Then, while steps S505 to S520 are repeated, when there is an incoming call (S510: YES), it is determined whether or not the incoming call is a call transmitted toward the IP phone (S530). Here, the incoming call transmitted toward the IP phone is an incoming call transmitted through the IP network 5, and accordingly, it is determined that an incoming call transmitted through the PSTN network 4 is not the incoming call transmitted toward the IP phone. In addition, if the incoming call is an incoming call toward the IP phone (S530: YES), the ring signal pattern for the IP phone starts to be transmitted (S540). On the other hand, if the incoming call is not an incoming call toward the IP phone (S530: NO), the ring signal pattern for the PSTN starts to be transmitted (S540).

Thereafter, the adaptor 3 determines whether or not the phone has connected the line thereto (S545). If the line is not connected thereto (S545: NO), the incoming call is monitored (S550). If the incoming call does not stop (S555: NO), the process returns to step S545 and the processes in steps S545 to S555 are repeated, such that the adaptor 3 waited until the phone connects the line thereto or the incoming call stops. Here, if the incoming call stops (S555: YES), a ring signal transmitted toward the phone is stopped (S560), returning to step S505.

In addition, if the phone has connected the line thereto (S545: YES), the ring signal transmitted toward the phone is stopped (S565) and then a call connection process is performed (S570). The call connection process allows the multi-function product 1 to be connected to a communication network, through which the incoming call has been transmitted, through the adaptor 3, resulting in a communicative state. Then, if the phone does not disconnect the line (S575: NO), the process proceeds to step S575 in which the line disconnection performed by the phone is awaited. Then, if the phone disconnects the line (S575: YES), the process returns to step S505.

On the other hand, if the phone connects the line thereto while the processes in steps S505 to S520 are repeated (S520: YES), it is assumed that there is a high possibility of an IP phone line, which is cheap, being used if there is no special reason. Accordingly, the phone connection process is first performed (S580), the adaptor 3 is connected to the IP phone line (IP network 5) (S585), a dial tone for IP phone is transmitted toward the phone (S590), and the line disconnection performed by the phone is monitored (S595).

Here, when the phone has disconnected the line (S600: YES), the process returns to step S505 because the line is disconnected without an actual signal transmission even though the line is connected to the phone.

On the other hand, if the phone has not disconnected the line (S600: NO), a dial input through the phone is monitored (S605). Here, if one number is not input (S610: NO), the process proceeds to step S605. However, if one number is input (S610: YES), the phone is connected to the PSTN line (S620). In addition, if the head of the dialed number is 101 (S615: YES), another dial input is monitored (S625). In addition, it is determined whether or not four numbers from the head of the dialed number are all ‘0’ (S630), and if the four numbers are all ‘0’ (S630: YES), the phone is connected to the PSTN line (S620).

That is, in the case in which the head of the dialed number is not ‘0’ and the case in which the four numbers from the head of the dialed number are ‘0000’, the PSTN network 4 is selected as the source end user communication network in the process in step S620. In other cases, the IP network 5 is selected as the source end user communication network in the process in step S585.

Subsequently, the monitoring of the line disconnection performed by the phone is performed (S635). If the phone does not disconnect the line (S640: NO), the process returns to step S635 in which the monitoring of the line disconnection performed by the phone is continued. In addition, if the phone has disconnected the line (S640: YES), the process returns to step S505.

[Effects of Call Process]

According to the multi-function product 1 described above, at the time when the incoming signal is detected, it is specified whether the source end user communication network is the PSTN network 4 or the IP network 5 on the basis of a call notice signal transmitted from the adaptor 3 and it is specified whether another end user communication network is the PSTN network 4 or the IP network 5 or the mobile phone network 6 on the basis of the caller number information transmitted through another end user communication network used by the remote communication apparatus.

Further, at the time of transmitting a signal, it is specified whether the source end user communication network is the PSTN network 4 or the IP network 5 on the basis of the phone number of the remote communication apparatus or the number (for example, 0000) included in the head of the phone number and it is specified whether another end user communication network is the PSTN network 4 or the IP network 5 or the mobile phone network 6 on the basis of the phone number of the remote communication apparatus.

Furthermore, even at the time when the incoming signal is detected through the catch display intervening during the communication, it is specified whether the source end user communication network is the PSTN network 4 or the IP network 5 on the basis of the call notice signal transmitted from the adaptor 3 and it is specified whether another end user communication network is the PSTN network 4 or the IP network 5 or the mobile phone network 6 on the basis of the caller number information transmitted through another end user communication network used by the remote communication apparatus.

Moreover, the sound parameter is selected according to the combination of the source end user communication network and another end user communication network, which are specified, and thus different signal processing is performed with respect to voice signals transmitted between the source end user's apparatus and the remote communication apparatus. That is, in the invention, even though there is a difference between the source end user communication network and another end user communication network, a signal processing is performed by considering the sound characteristic due to the difference in the source end user communication network or another end user communication network. Accordingly, a transmitted voice or a received voice can be converted to a clearly audible voice even if the source end user communication network is any one of the PSTN network 4 and the IP network 5, as compared with a communication apparatus in which only the same signal processing is performed with respect to the voice signals transmitted between the source end user's apparatus and the remote communication apparatus. In addition, even if the source end user communication network is any one of the PSTN network 4, the IP network 5, and the mobile phone network 6, the transmitted voice or the received voice can be converted to a clearly audible voice.

[Facsimile Transmission Processing]

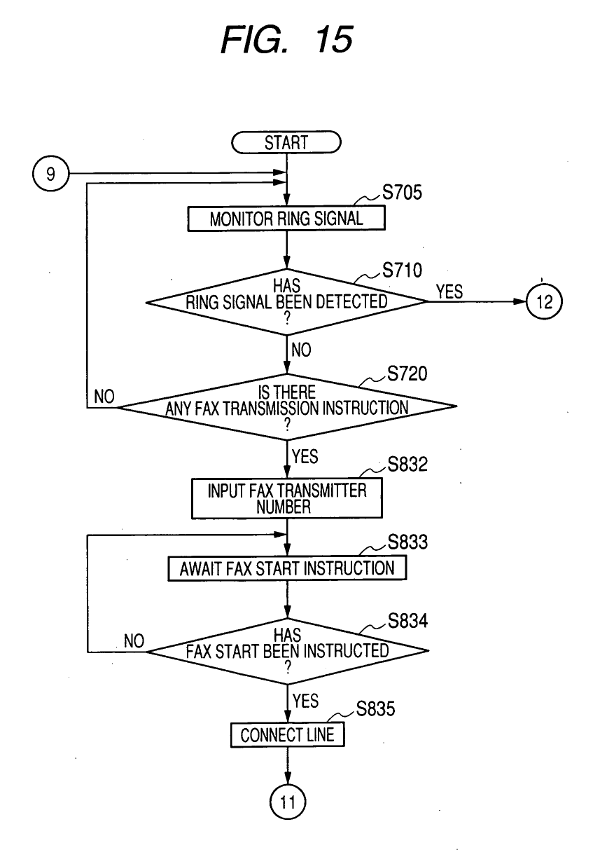

Next, a facsimile transmission processing performed by multi-function product 1 will be described with reference to flowcharts shown in FIGS. 15 to 19. In addition, the flow charts shown in FIGS. 15 to 19 illustrate processes related to the aspect of the invention, among processes normally performed by the CPU 11 of the multi-function product 1. Even though the CPU 11 performs other processes, which are not shown in FIGS. 15 to 19, the processes not related to the aspect of the invention are not shown.

In the facsimile transmission processing to be described below, an initial communication speed is set in consideration of the transmission characteristics of the source end user communication network and an other end user communication network. Specifically, in the present aspect, the initial communication speed is selected among three kinds of speed, that is, ‘V.29 9600 bps’, ‘V.17 14400 bps’, and ‘V.34 33600 bps’. In addition, in the case in which the facsimile transmission processing is performed through a communication network in which delay of a signal occurs easily, a low speed communication is performed so as to suppress communication error from occurring, and in the case in which the facsimile transmission processing is performed through a communication network in which delay of a signal does not occur easily, a high speed communication is performed so as to reduce the transmission time.

First, as shown in FIG. 15, when a process starts by the CPU11, a ring signal transmitted through the adaptor 3 is monitored (S705). If there is no ring signal (S710: NO), it is determined whether or not a FAX transmission instruction exists (S720). If the FAX transmission instruction does not exist (S720: NO), the process returns to step S705. Thus, while there is no ring signal and the FAX transmission instruction, the processes in steps S705 to S720 are repeated such that the determination on whether or not the FAX transmission instruction exist and the monitoring on the ring signal are continued.

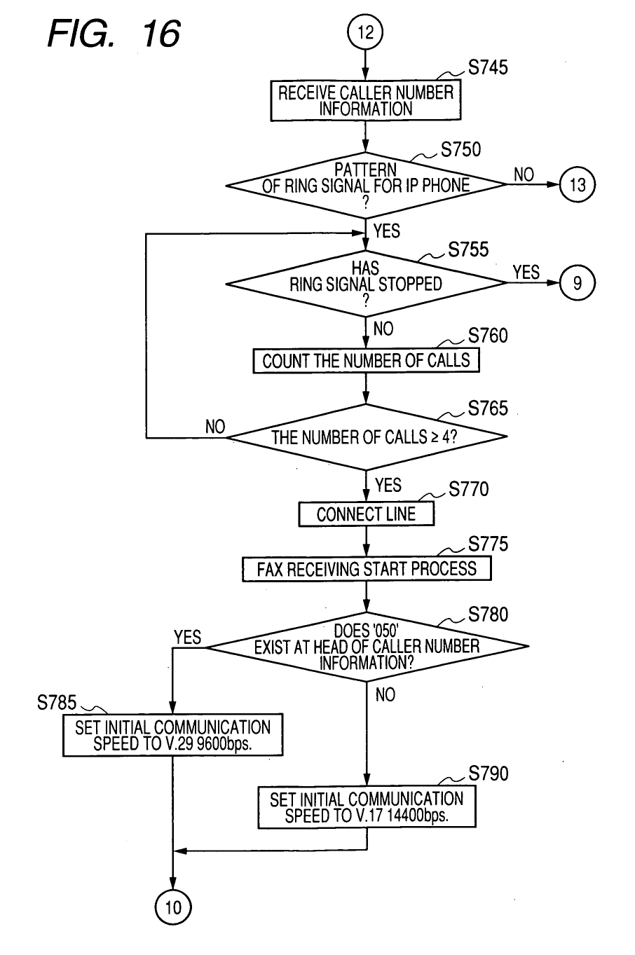

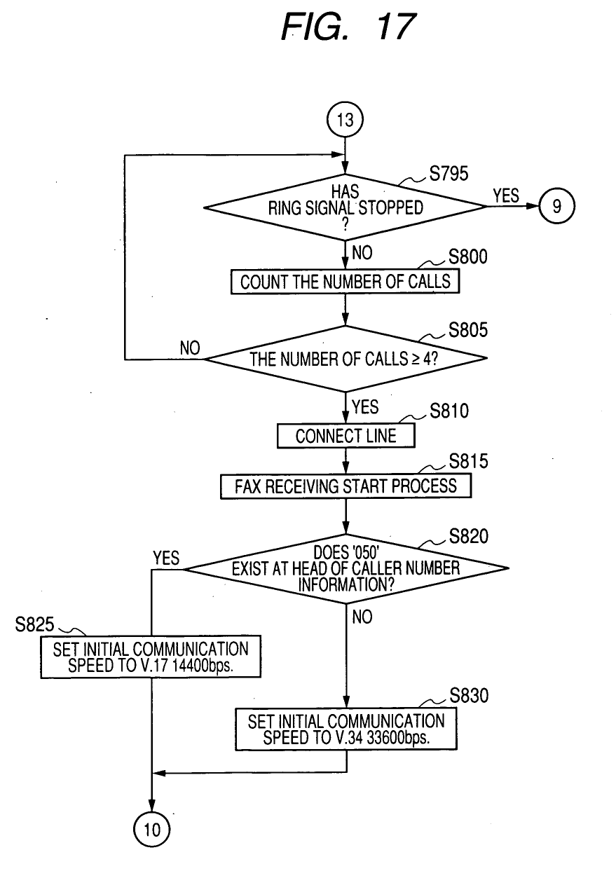

Then, while steps S705 to S720 are repeated, when a ring signal is transmitted from the adaptor 3 in response to an incoming signal transmitted from the remote communication apparatus (S710: YES), the process proceeds to a process performed when the incoming signal is detected, which is shown in FIGS. 16 and 17. In the process performed when the incoming signal is detected, the caller number information transmitted from the remote communication apparatus is received (S745), and then it is determined whether or not the ring signal is a pattern of a ring signal to be transmitted to an IP phone (S750).

Here, when the incoming signal has been transmitted through the IP network 5, the signal pattern of the ring signal becomes a ring signal pattern toward the IP phone (S750: YES), and in this case, the process proceeds to processes (refer to FIG. 16) when the incoming signal has been transmitted through the IP network 5, which are shown in steps S755 to S790. In addition, when the incoming signal has been transmitted through the PSTN network 4, the signal pattern of the ring signal does not become a ring signal pattern toward the IP phone (S750: NO), and in this case, the process proceeds to processes (refer to FIG. 17) when the incoming signal has been transmitted through the PSTN network 4, which are shown in steps S795 to S830.

If the process proceeds to processes in steps S755 to S790 performed when the incoming signal has been transmitted through the IP network 5, it is first determined whether or not the ring signal has stopped (S755). If it is determined that the ring signal has not stopped (S755: NO), the number of calls is counted (S760), and if the number of calls is less than 4 (S765: NO), the process returns to step S755. Thus, while the ring signal does not stop and the number of calls is less than 4, the processes in steps S755 to S765 are repeated.

Here, when the ring signal has stopped (S755: YES), the facsimile transmission (or a phone call) is stopped. Accordingly, the process returns to step S705 (refer to FIG. 15) so as to repeat steps S705 to S720.

On the other hand, if the number of calls reaches 4 or more while steps S755 to S765 are repeated (S765: YES), the line is connected (S770) and a FAX receiving start process is performed (S775).

Thereafter, the initial communication speed is set through the processes S780 to S790. Here, since a positive determination has been made in step S750 and thus it has been already determined that the source end user communication network is the IP network 5, it is determined that another end user communication network corresponds to which one of the PSTN network 4 and the IP network 5. According to the determination result, a setting on the communication speed is performed.

Specifically, first, the CPU 11 determines whether or not ‘050’ exists at the head of the caller number information (S780) If the ‘050’ exists at the head of the caller number information (S780: YES), the remote communication apparatus is a device (for example, a facsimile device corresponding to the IP phone 5a) using the IP network 5, and each of both the source end user communication network and another end user communication network is the IP network 5. For this reason, in this case, each of both the source end user communication network and another end user communication network is the IP network 5 in which a signal delay occurs easily. Accordingly, in this case, in order to suppress the communication error due to the signal delay from occurring, the initial communication speed is set to V.29 9600 bps, which is the lowest speed (S785).

Further, in step S780, if ‘050’ does not exist at the head of the caller number information (S780: NO), the remote communication apparatus is a device (for example, a facsimile device corresponding to the phone 4a) using the PSTN network 4, the source end user communication network is the IP network 5, and another end user communication network is the PSTN network 4. For this reason, in this case, only the source end user communication network is the IP network 5 in which the signal delay occurs easily. Accordingly, in this case, in order to suppress the communication error due to the signal delay from occurring and to increase the communication speed, the initial communication speed is set to V.17 14400 bps (S790).

After the initial communication speed has been set through steps S780 to S790 described above, the process proceeds to an actual communication processing, but the actual communication processing will be described below.

On the other hand, as a result of the determination in step S750, if the process proceeds to processes in steps S795 to S830 performed when the incoming signal has been transmitted through the PSTN network 4, it is first determined whether or not the ring signal has stopped (S795). If it is determined that the ring signal has not stopped (S795: NO), the number of calls is counted (S800), and if the number of calls is less than 4 (S805: NO), the process returns to step S795. Thus, while the ring signal does not stop and the number of calls is less than 4, the processes in steps S795 to S805 are repeated.

Here, when the ring signal has stopped (S795: YES), the facsimile transmission (or a phone call) is stopped. Accordingly, the process returns to step S705 (refer to FIG. 15) so as to repeat steps S705 to S720.

On the other hand, if the number of calls reaches 4 or more while steps S795 to S805 are repeated (S805: YES), the line is connected (S810) and the FAX receiving start process is performed (S815).

Thereafter, the initial communication speed is set through the processes S820 to S830. Here, since a negative determination has been made in step S750 and thus it has already been determined that the source end user communication network is the PSTN network 4, it is determined that another end user communication network corresponds to which one of the PSTN network 4 and the IP network 5. According to the determination result, the communication speed is set.

Specifically, first, the CPU 11 determines whether or not ‘050’ exists at the head of the caller number information (S820). If ‘050’ exists at the head of the caller number information (S820: YES), the remote communication apparatus is a device (for example, a facsimile device corresponding to the IP phone 5a) using the IP network 5, the source end user communication network is the PSTN network 4, and another end user communication network is the IP network 5. For this reason, in this case, only another end user communication network is the IP network 5 in which the signal delay occurs easily. Accordingly, in this case, in order to suppress the communication error due to the signal delay from occurring and to increase the communication speed, the initial communication speed is set to V.17 14400 bps (S825).

Further, in step S820, if ‘050’ does not exist at the head of the caller number information (S820: NO), the remote communication apparatus is a device (for example, a facsimile device corresponding to the phone 4a) using the PSTN network 4, the source end user communication network is the PSTN network 4, and another end user communication network is also the PSTN network 4. For this reason, in this case, each of both the source end user communication network and another end user communication network is not the IP network 5 in which the signal delay occurs easily. Accordingly, in this case, in order to increase the communication speed as much as possible, the initial communication speed is set to V.34 36600 bps, which is the highest speed (S830).

After the initial communication speed has been set through steps S820 to S830 described above, the process proceeds to the actual communication processing, but the actual communication processing will be described below.

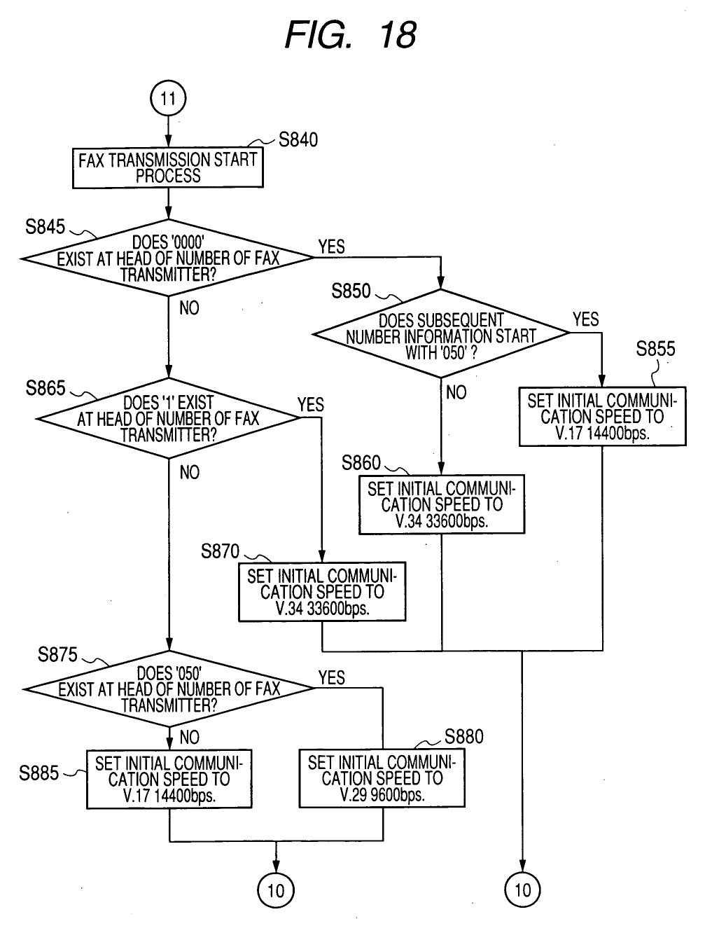

Until now, the case in which the process proceeds a process performed when an incoming signal is detected has been described with reference to FIGS. 16 and 17. If there is the FAX transmission instruction while the processes in steps S705 to S720 are repeated (S720: YES), a number of a FAX transmitter is received (S832). Then, an instruction on a FAX transmission start waits (S833). If the FAX transmission start is not instructed (S834: NO), the process returns to step S833, and if the FAX transmission start is instructed (S834: YES), the line is connected (S835) and then the process proceeds to a signal transmission process, which is shown in FIG. 18.

In the signal transmission process, first, a FAX transmission start processing is performed (S840). Then, it is determined whether ‘0000’ exists at the head of the number of the FAX transmitter (S845). As already described in the communication processing, this is also a process according to the specifications of the adaptor 3. Accordingly, if ‘0000’ exists at the head of a dialed number at the time of a call, the multi-function product 1 determines that the source end user communication network is the PSTN network 4.

If ‘0000’ exists at the head of the number of the FAX transmitter (S845: YES), it is determined whether or not subsequent number information starts with ‘050’ (S850). When the subsequent number information starts with ‘050’ (S850: YES), the remote communication apparatus is a device (for example, a facsimile device corresponding to the IP phone 5a) using the IP network 5, the source end user communication network is the PSTN network 4, and another end user communication network is the IP network 5. Accordingly, in this case, the initial communication speed is set to V.17 14400 (S855).

Further, in step S850, if the subsequent number information does not start with ‘050’ (S850: NO), the remote communication apparatus is a device (for example, a facsimile device corresponding to the phone 4a) using the PSTN network 4, the source end user communication network is the PSTN network 4, and another end user communication network is also the PSTN network 4. Accordingly, in this case, the initial communication speed is set to V.34 33600 (S860).

In addition, if ‘0000’ does not exist at the head of the number of the FAX transmitter (S845: NO), it is determined whether or not ‘1’ exists at the head of the dialed number (S865). As already described in the communication processing, this is also a process according to the specifications of the adaptor 3. Accordingly, if ‘1’ exists at the head of the dialed number at the time of the call, the multi-function product 1 determines that the source end user communication network is the PSTN network 4.

If ‘1’ exists at the head of the number of the FAX transmitter (S865: YES), the remote communication apparatus is a device (for example, a facsimile device corresponding to the phone 4a) using the PSTN network 4, the source end user communication network is the PSTN network 4, and another end user communication network is also the PSTN network 4. Accordingly, in this case, the initial communication speed is set to V.34 33600 (S870).

After the initial communication speed has been set through steps S850 to S860 described above, the process proceeds to the actual communication processing, but the actual communication processing will be described later.

On the other hand, if ‘1’ does not exist at the head of the number of the FAX transmitter (S865: NO), it is determined whether ‘050’ exists at the head of the number of the FAX transmitter (S875). If ‘050’ exists at the head of the number of the FAX transmitter (S875: YES), the remote communication apparatus is a device (for example, a facsimile device corresponding to the IP phone 5a) using the IP network 5, the source end user communication network is the IP network 5, and another end user communication network is also the IP network 5. Accordingly, in this case, the initial communication speed is set to V.29 9600 bps (S880).

In addition, in step S875, if ‘050’ does not exist at the head of the number of the FAX transmitter (S875: NO), the remote communication apparatus is a device (for example, a facsimile device corresponding to the phone 4a) using the PSTN network 4, the source end user communication network is the IP network 5, and another end user communication network is the PSTN network 4. For this reason, in this case, the initial communication speed is set to V.17 14400 (S885).

After the initial communication speed has been set through steps S865 to S885 described above, the process proceeds to the actual communication processing.

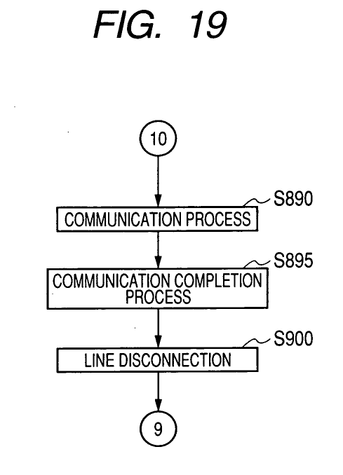

Further, among the processes described above, the actual communication processing performed after the initial communication speed has been set is shown in FIG. 19. Referring to FIG. 19, a communication process of transmitting/receiving facsimile data is first performed (S890). Then, if all facsimile data has been transmitted/received by the communication process, a communication completion process is performed (S900). Thus, the line is disconnected (S910) and the process returns to step S705.

[Effects of the Facsimile Transmission Process]

According to the multi-function product 1 describe above, at the time when the FAX is received, it is specified whether the source end user communication network is the PSTN network 4 or the IP network 5 on the basis of a call notice signal transmitted from the adaptor 3 and it is specified whether another end user communication network is the PSTN network 4 or the IP network 5 on the basis of the caller number information transmitted through another end user communication network used by the remote communication apparatus.

Further, at the time of transmitting the FAX, it is specified whether the source end user communication network is the PSTN network 4 or the IP network 5 on the basis of the phone number of the remote communication apparatus or the number (for example, 0000) included in the head of the phone number and it is specified whether another end user communication network is the PSTN network 4 or the IP network 5 on the basis of the phone number of the remote communication apparatus.

In addition, by properly selecting the initial communication speed according to the combination of the source end user communication network and another end user communication network, which are specified, facsimile images are transmitted at different communication speeds. That is, in the invention, as compared with a communication apparatus in which facsimile images are transmitted only in the same communication speed even though there is a difference between the source end user communication network and another end user communication network, it can be prevented that the communication speed becomes excessively fast even though a delay occurs easily or the communication speed becomes excessively slow even though a delay does not occur easily.

While the invention has been described with reference to the above-mentioned aspects, the invention can be implemented in different forms without being limited to the above-mentioned aspects.

For example, in the aspect described above, even though the multi-function product 1 has been exemplified as the communication apparatus of the invention, the invention can be applied to, for example, a phone or a facsimile device other than the multi-function product 1.

Further, in the aspect described above, even though the mobile phone network has been identified by using ‘090’ in order to avoid the explanation from being complicated, it is preferable to use, for example, ‘080’ or ‘070’ other than ‘090’ in order to identify the IP network because ‘080’, ‘070’, and the like are numbers for identifying the mobile phone network.

In the same manner, in the aspect described above, the number (for example, 110, 119) of which a head starts with ‘1’ or ‘0000’ set as the specifications of the adaptor 3 has been exemplified as the number to be identified as the PSTN network. However, for example, since ‘0120’ or ‘0990’ is a number used for communication through the PSTN network in Japan, those numbers may be used to identify the PSTN network.

Furthermore, as the IP phones or the mobile phones are widely used recently, those numbers may be changed or new numbers may be assigned, and accordingly, such new numbers can be applied to the invention. That is, in the present aspect, it is not important to use the specified numbers, such as ‘090’ or ‘050’ exemplified above.

Further, there are two kinds of voice signals transmitted between the communication apparatus and the remote communication apparatus, that is, a voice signal transmitted to the remote communication apparatus and a voice signal transmitted from the remote communication apparatus. Here, it is most effective to apply the invention for both the voice signals. However, even though the invention is applied for one of the voice signals, the same effects can be obtained. That is, the invention may be applied for both a voice transmitter and a voice receiver, or for only the voice transmitter, or for only the voice receiver. For example, in the case when the invention is applied for the voice transmitter, even if a voice made by a user of the communication apparatus is too small or too large, the voice can be corrected to have a proper voice volume or a proper voice quality and then the corrected voice can be transmitted to the remote communication apparatus. In addition, in the case when the invention is applied for the voice receiver, even if a voice transmitted from the remote communication apparatus is too small or too large, the voice can also be corrected to have a proper voice volume or a proper voice quality and thus the user of the communication apparatus can listen to the corrected voice.

In addition, in FIG. 4, a connection type is exemplified in which the communication line for connection with the IP network and the communication line for connection with the PSTN network are connected to the adaptor 3, respectively. However, depending on the adaptor 3, there is a connection type (for example, ADSL) in which a single communication line prepared for the connection with the PSTN network is also used for the connection with the IP network, and any one of the connection types described above can be used in the present aspect.

As was described, according to the second aspect of the invention, there is provided a communication apparatus that is capable of communicating with a remote communication apparatus through a source end user communication network to which the communication apparatus is connected and another end user communication network to which the remote communication apparatus is connected and that is connected to a relay device connected to both an IP network and a PSTN network so that each of the IP network and the PSTN network can be used as the source end user communication network includes: a source end user communication network determination unit used when a signal is received that, when the signal is received from the remote communication apparatus, determines whether the received signal is a signal received through the IP network or a signal received through the PSTN network on the basis of a call notice signal transmitted from the source end user communication network or the relay device; and a voice signal processing unit that performs different signal processing for voice signals transmitted between the communication apparatus and the remote communication apparatus with respect to a case in which the received signal has been received through the IP network and a case in which the received signal has been received through the PSTN network, those cases being determined by the source end user communication network determination unit used when the signal is received.

According to the communication apparatus described above, the source end user communication network used by the communication apparatus is specified on the basis of the call notice signal transmitted when a signal is received, and different signal processing is performed for the voice signals transmitted between the communication apparatus and the remote communication apparatus depending on the specified source end user communication network.

Therefore, for example, it is possible to perform a first signal processing by which a voice received through the IP network is clearly audible when a signal is received through the IP network and to perform a second signal processing by which a voice received through the PSTN network is clearly audible when the signal is received through the PSTN network.

In the case of a communication apparatus in which only the same signal processing when a signal is transmitted through the IP network and the PSTN network is performed for voice signals transmitted between the communication apparatus and the remote communication apparatus, for example, even if the communication apparatus performs a first signal processing by which a voice received through the IP network is converted to a clearly audible voice, a voice received through the PSTN network is not necessarily converted to a clearly audible voice. In addition, even if the communication apparatus performs a second signal processing which converts a voice received through the PSTN network to a clearly audible voice, a voice received through the IP network is not necessarily converted to a clearly audible voice. However, in the communication apparatus according to the aspect of the invention, both the voices received through the IP network and the PSTN network can be converted to clearly audible voices.

In addition, the signal processing performed by the voice signal processing unit includes a process of increasing/decreasing a voice volume, a process of changing an echo canceling level, a process of cutting a frequency band in which many noises are mixed, for example. More specifically, in the case of the source end user communication network, if there is a difference in the voice volume between the PSTN network and the IP network, the level of the process of increasing/decreasing the voice volume between the PSTN network and the IP network is changed such that the difference can be reduced. Further, if there is a difference of echo between the PSTN network and the IP network, the echo canceling level between the PSTN network and the IP network is changed such that the difference can be reduced. Furthermore, if there is a difference in an amount of noise or noise frequencies between the PSTN network and the IP network, the filter characteristic between the PSTN network and the IP network is changed such that the difference can be reduced. Here, those processes may be arbitrarily combined or the effects due to those processes can be arbitrarily decided. In addition, among the signal processing for the PSTN network and the IP network performed by combining those processes, a processing that a user cannot arbitrarily change may be set beforehand, or it is also possible to set such that the user can arbitrarily change any processing.

Further, according to the second aspect of the invention, it is preferable to further include another end user communication network determination unit used when a signal is received that, when the signal is received from the remote communication apparatus, determines the type of another end user communication network on the basis of a phone number of the remote communication apparatus transmitted from another end user communication network. In addition, preferably, the voice signal processing unit performs different signal processing for the voice signals transmitted between the communication apparatus and the remote communication apparatus, depending on a combination of a determination result obtained by the source end user communication network determination unit used when the signal is received and a determination result obtained by another end user communication network determination unit used when the signal is received.

According to the communication apparatus described above, the source end user communication network used by the communication apparatus is specified on the basis of the call notice signal transmitted when the signal is received, another end user communication network used by the remote communication apparatus is specified on the basis of the phone number of the remote communication apparatus transmitted when the signal is received, and different signal processing is performed for the voice signals transmitted between the communication apparatus and the remote communication apparatus depending on the combination of the specified source end user communication network and the specified another end user communication network.

Therefore, it is possible to perform a signal processing in consideration of a characteristic of another end user communication network as well as a characteristic of the source end user communication network. As a result, in any combination of the source end user communication network and another end user communication network, the voice can be converted to a clearly audible voice.

In addition, another end user communication network that can be determined on the basis of the phone number includes the IP network, the PSTN network, and the mobile phone network. Here, it is most preferable to perform the signal processing by recognizing each of the IP network, the PSTN network, and the mobile phone network as different end user communication networks. However, even in a case when the IP network and networks other than the IP network are recognized as different end user communication networks or a case when the PSTN network and networks other than the PSTN network are recognized as different end user communication networks, it is possible to obtain effects corresponding to the case in which each of the IP network, the PSTN network, and the mobile phone network is recognized as different end user communication networks.

In addition, the signal processing performed by the voice signal processing unit includes a process of increasing/decreasing a voice volume, a process of changing an echo canceling level, a process of cutting a frequency band in which many noises are mixed. For example, if there is a difference in the voice volume among a case in which another end user communication network is the PSTN network, a case in which another end user communication network is the IP network, and a case in which another end user communication network is the mobile phone network, the level of the process of increasing/decreasing the voice volume may be changed such that the difference can be reduced. Similarly, the echo canceling process, the noise cutting process, or the like may be applied.

Further, according to the second aspect of the invention, there is provided a communication apparatus that is capable of communicating with a remote communication apparatus through a source end user communication network to which the communication apparatus is connected and another end user communication network to which the remote communication apparatus is connected and that is connected to a relay device connected to both an IP network and a PSTN network so that each of the IP network and the PSTN network can be used as the source end user communication network includes: a source end user communication network determination unit used when a signal is transmitted that, when the signal is transmitted to the remote communication apparatus, determines whether the signal is to be transmitted through the IP network or the signal is to be transmitted through the PSTN network on the basis of an input operation that a user has performed or a phone number of the remote communication apparatus; and a voice signal processing unit that performs different signal processing for voice signals transmitted between the communication apparatus and the remote communication apparatus with respect to a case in which the signal is to be transmitted through the IP network and a case in which the signal is to be transmitted through the PSTN network, those cases being determined by the source end user communication network determination unit used when the signal is transmitted.

In the communication apparatus described above, various operations may be considered as an input operation that a user performs at the time of a call. For example, if there is an exclusive line selection button provided so as that a user can arbitrarily select the IP network or the PSTN network, an operation of pressing the exclusive line selection button corresponds to the input operation that a user performs at the time of a call. In addition, in the case in which the PSTN network is selected if a predetermined number (for example, ‘0000’) is input before inputting a phone number of the remote communication apparatus and the IP network is selected if the predetermined number is not input, an operation of inputting the predetermined number corresponds to the input operation that a user performs at the time of a call. In addition, among phone numbers of the remote communication apparatuses, there exists a phone number (for example, ‘110’) for which the PSTN network should be used. Accordingly, when making a call to such phone number, it is possible to specify a source end user communication network used by the user on the basis of such phone numbers.

According to the communication apparatus described above, the source end user communication network used by the communication apparatus is specified on the basis of an input operation that a user has performed at the time of a call or a phone number of the remote communication apparatus, and different signal processing is performed for the voice signals transmitted between the communication apparatus and the remote communication apparatus according to the specified source end user communication network.

Therefore, for example, it is possible to perform a first signal processing which converts a voice transmitted through the IP network to a clearly audible voice when a signal is transmitted through the IP network and to perform a second signal processing which converts a voice transmitted through the PSTN network to a clearly audible voice when the signal is transmitted through the PSTN network. As a result, both the voices transmitted through the IP network and the PSTN network can be converted to clearly audible voices.

Furthermore, according to the second aspect of the invention, it is preferable to further include another end user communication network determination unit used when a signal is transmitted that, when the signal is transmitted to the remote communication apparatus, determines the type of another end user communication network on the basis of a phone number of the remote communication apparatus. In addition, preferably, the voice signal processing unit performs different signal processing for the voice signals transmitted between the communication apparatus and the remote communication apparatus, depending on a combination of a determination result obtained by the source end user communication network determination unit used when the signal is transmitted and a determination result obtained by another end user communication network determination unit used when the signal is transmitted.

According to the communication apparatus described above, the source end user communication network used by the communication apparatus is specified on the basis of an input operation that a user has performed at the time of a call or a phone number of the remote communication apparatus, another end user communication network used by the remote communication apparatus is specified on the basis of a phone number of the remote communication apparatus, and different signal processing is performed for the voice signals transmitted between the communication apparatus and the remote communication apparatus depending on the combination of the specified source end user communication network and the specified another end user communication network.

Therefore, it is possible to perform a signal processing in consideration of the characteristic of another end user communication network as well as the characteristic of the source end user communication network. As a result, in any combination of the source end user communication network and another end user communication network, the voice can be converted to a clearly audible voice.

Further, according to the second aspect of the invention, there is provided a communication apparatus that is capable of communicating with a remote communication apparatus through a source end user communication network to which the communication apparatus is connected and another end user communication network to which the remote communication apparatus is connected and that is connected to a relay device connected to both an IP network and a PSTN network so that each of the IP network and the PSTN network can be used as the source end user communication network includes: a source end user communication network determination unit used when a signal is received that, when the signal is received from the remote communication apparatus, determines whether the received signal is a signal received through the IP network or a signal received through the PSTN network on the basis of a call notice signal transmitted from the source end user communication network or the relay device; a source end user communication network determination unit used when a signal is transmitted that, when the signal is transmitted to the remote communication apparatus, determines whether the signal is to be transmitted through the IP network or the signal is to be transmitted through the PSTN network on the basis of an input operation that a user has performed or a phone number of the remote communication apparatus; and a voice signal processing unit that performs different signal processing for voice signals transmitted between the communication apparatus and the remote communication apparatus with respect to a case in which the received signal has been received through the IP network and a case in which the received signal has been received through the PSTN network, those cases being determined by the source end user communication network determination unit used when the signal is received, and that performs different signal processing for the voice signals transmitted between the communication apparatus and the remote communication apparatus with respect to a case in which the signal is to be transmitted through the IP network and a case in which the signal is to be transmitted through the PSTN network, those cases being determined by the source end user communication network determination unit used when the signal is transmitted.

Accordingly, it is possible to perform a first signal processing by which a voice received or transmitted through the IP network is clearly audible when a signal is received or transmitted through the IP network and to perform a second signal processing by which a voice received or transmitted through the PSTN network is clearly audible when the signal is received or transmitted through the PSTN network. As a result, both the voices received or transmitted through the IP network and the PSTN network can be converted to clearly audible voices.

Further, according to the second aspect of the invention, it is preferable to further include: another end user communication network determination unit used when a signal is received that, when the signal is received from the remote communication apparatus, determines the type of another end user communication network on the basis of a phone number of the remote communication apparatus transmitted from another end user communication network; and another end user communication network determination unit used when a signal is transmitted that, when the signal is transmitted to the remote communication apparatus, determines the type of another end user communication network on the basis of a phone number of the remote communication apparatus. In addition, preferably, the voice signal processing unit performs different signal processing for the voice signals transmitted between the communication apparatus and the remote communication apparatus, depending on a combination of a determination result obtained by the source end user communication network determination unit used when the signal is received and a determination result obtained by another end user communication network determination unit used when the signal is received, and performs different signal processing for the voice signals transmitted between the communication apparatus and the remote communication apparatus, depending on a combination of a determination result obtained by the source end user communication network determination unit used when the signal is transmitted and a determination result obtained by another end user communication network determination unit used when the signal is transmitted.

Therefore, it is possible to perform a signal processing in consideration of the characteristic of another end user communication network as well as the characteristic of the source end user communication network. As a result, in any combination of the source end user communication network and another end user communication network, the voice can be converted to a clearly audible voice.

Furthermore, according to the second aspect of the invention, it is preferable to further include a source end user communication network determination unit used when a signal is received during communication that, when the signal is received from a second remote communication apparatus while the communication apparatus is in communication with a first communication apparatus, determines whether the signal received from the second remote communication apparatus is a signal received through the IP network or a signal received through the PSTN network on the basis of a call notice signal transmitted from the source end user communication network or the relay device. In addition, preferably, the voice signal processing unit performs different signal processing for voice signals transmitted between the communication apparatus and the second remote communication apparatus with respect to a case in which the signal received from the second remote communication apparatus has been received through the IP network and a case in which the signal received from the second remote communication apparatus has been received through the PSTN network, those cases being determined by the source end user communication network determination unit used when the signal is received during communication.

According to the communication apparatus described above, even when the signal is received from the second remote communication apparatus while the communication apparatus is in communication with the first communication apparatus, the source end user communication network used by the communication apparatus is specified with respect to the second remote communication apparatus, and then different signal processing is performed for voice signals transmitted between the communication apparatus and the second remote communication apparatus depending on the specified source end user communication network.

Therefore, even for the second remote communication apparatus, for example, it is possible to perform a first signal processing by which a voice received through the IP network is clearly audible when a signal is received through the IP network and to perform a second signal processing by which a voice received through the PSTN network is clearly audible when the signal is received through the PSTN network. As a result, both the voices received through the IP network and the PSTN network can be converted to clearly audible voices.

Furthermore, according to the second aspect of the invention, it is preferable to further include another end user communication network determination unit used when a signal is received during communication that, when the signal is received from the second remote communication apparatus, determines the type of another end user communication network on the basis of a phone number of the second remote communication apparatus transmitted from another end user communication network. In addition, preferably, the voice signal processing unit performs different signal processing for voice signals transmitted between the communication apparatus and the second remote communication apparatus, depending on a combination of a determination result obtained by the source end user communication network determination unit used when the signal is received during communication and a determination result obtained by another end user communication network determination unit used when the signal is received during communication.

According to the communication apparatus described above, even when the signal is received from the second remote communication apparatus, the source end user communication network used by the communication apparatus is specified on the basis of the call notice signal transmitted when the signal is received, another end user communication network is specified on the basis of the phone number of the remote communication apparatus transmitted when the signal is received, and different signal processing is performed for the voice signals transmitted between the communication apparatus and the remote communication apparatus depending on the combination of the specified source end user communication network and the specified another end user communication network.

Therefore, even for the second remote communication apparatus, it is possible to perform a signal processing in consideration of a characteristic of another end user communication network as well as a characteristic of the source end user communication network. As a result, in any combination of the source end user communication network and another end user communication network, the voice can be converted to a clearly audible voice.

Furthermore, according to the second aspect of the invention, there is provided a communication apparatus that has a facsimile function, is capable of communicating with a remote communication apparatus through a source end user communication network to which the communication apparatus is connected and another end user communication network to which the remote communication apparatus is connected, and is connected to a relay device connected to both an IP network and a PSTN network so that each of the IP network and the PSTN network can be used as the source end user communication network includes: a source end user communication network determination unit used when a signal is received that, when the signal is received from the remote communication apparatus, determines whether the received signal is a signal received through the IP network or a signal received through the PSTN network on the basis of a call notice signal transmitted from the source end user communication network or the relay device; and a communication control unit that, when facsimile images are transmitted between the communication apparatus and the remote communication apparatus, makes the facsimile images transmitted at different communication speeds with respect to a case in which the received signal has been received through the IP network and a case in which the received signal has been received through the PSTN network, those cases being determined by the source end user communication network determination unit used when the signal is received.

This communication apparatus is different from the above-mentioned communication apparatus in that it performs the transmission of facsimile images.

According to the communication apparatus described above, the source end user communication network used by the communication apparatus is specified on the basis of the call notice signal transmitted when a signal is received, and the facsimile images are transmitted at different communication speeds depending on the specified source end user communication network.

Therefore, for example, it is possible to prevent communication errors from occurring by decreasing the communication speed when the signal is received through the IP network in which delay occurs easily. In addition, it is possible to make the facsimile images transmitted quickly by increasing the communication speed when the signal is received through the PSTN network in which delay does not occur easily.

Further, according to the second aspect of the invention, it is preferable to further include another end user communication network determination unit used when a signal is received that, when the signal is received from the remote communication apparatus, determines the type of another end user communication network on the basis of a phone number of the remote communication apparatus transmitted from another end user communication network. In addition, preferably, the communication control unit makes the facsimile images transmitted at different communication speeds depending on a combination of a determination result obtained by the source end user communication network determination unit used when the signal is received and a determination result obtained by another end user communication network determination unit used when the signal is received.

According to the communication apparatus described above, the source end user communication network used by the communication apparatus is specified on the basis of the call notice signal transmitted when the signal is received, another end user communication network used by the remote communication apparatus is specified on the basis of the phone number of the remote communication apparatus transmitted when the signal is received, and the facsimile images are transmitted at different communication speeds depending on the combination of the specified source end user communication network and the specified another end user communication network.

Therefore, it is possible to transmit the facsimile images in a communication speed in consideration of a characteristic of another end user communication network as well as a characteristic of the source end user communication network. As a result, in any combination of the source end user communication network and another end user communication network, it is possible to suppress communication errors from occurring and to make the facsimile images transmitted quickly.

Further, according to the second aspect of the invention, there is provided a communication apparatus that has a facsimile function, is capable of communicating with a remote communication apparatus through a source end user communication network to which the communication apparatus is connected and another end user communication network to which the remote communication apparatus is connected, and is connected to a relay device connected to both an IP network and a PSTN network so that each of the IP network and the PSTN network can be used as the source end user communication network includes: a source end user communication network determination unit used when a signal is transmitted that, when the signal is transmitted to the remote communication apparatus, determines whether the signal is to be transmitted through the IP network or the signal is to be transmitted through the PSTN network on the basis of an input operation that a user has performed or a phone number of the remote communication apparatus; and a communication control unit that, when facsimile images are transmitted between the communication apparatus and the remote communication apparatus, makes the facsimile images transmitted at different communication speeds with respect to a case in which the signal is to be transmitted through the IP network and a case in which the signal is to be transmitted through the PSTN network, those cases being determined by the source end user communication network determination unit used when the signal is transmitted.

According to the communication apparatus described above, the source end user communication network used by the communication apparatus is specified on the basis of an input operation that a user has performed or a phone number of the remote communication apparatus, and the facsimile images are transmitted at different communication speeds depending on the specified source end user communication network.

Therefore, for example, it is possible to suppress communication errors from occurring by decreasing the communication speed when the signal is transmitted through the IP network in which delay occurs easily. In addition, it is possible to make the facsimile images transmitted quickly by increasing the communication speed when the signal is transmitted through the PSTN network in which delay does not occur easily.

Further, according to the second aspect of the invention, it is preferable to further include another end user communication network determination unit used when a signal is transmitted that, when the signal is transmitted to the remote communication apparatus, determines the type of another end user communication network on the basis of a phone number of the remote communication apparatus. In addition, preferably, the communication control unit makes the facsimile images transmitted at different communication speeds depending on a combination of a determination result obtained by the source end user communication network determination unit used when the signal is transmitted and a determination result obtained by another end user communication network determination unit used when the signal is transmitted.

According to the communication apparatus described above, the source end user communication network used by the communication apparatus is specified on the basis of an input operation that a user has performed, another end user communication network used by the remote communication apparatus is specified on the basis of a phone number of the remote communication apparatus, and the facsimile images are transmitted at different communication speeds depending on the combination of the specified source end user communication network and the specified another end user communication network.

Therefore, it is possible to transmit the facsimile images in a communication speed in consideration of a characteristic of another end user communication network as well as a characteristic of the source end user communication network. As a result, in any combination of the source end user communication network and another end user communication network, it is possible to suppress communication errors from occurring and to make the facsimile images transmitted quickly.

Furthermore, according to the second aspect of the invention, there is provided a communication apparatus that has a facsimile function, is capable of communicating with a remote communication apparatus through a source end user communication network to which the communication apparatus is connected and another end user communication network to which the remote communication apparatus is connected, and is connected to a relay device connected to both an IP network and a PSTN network so that each of the IP network and the PSTN network can be used as the source end user communication network includes: a source end user communication network determination unit used when a signal is received that, when the signal is received from the remote communication apparatus, determines whether the received signal is a signal received through the IP network or a signal received through the PSTN network on the basis of a call notice signal transmitted from the source end user communication network or the relay device; a source end user communication network determination unit used when a signal is transmitted that, when the signal is transmitted to the remote communication apparatus, determines whether the signal is to be transmitted through the IP network or the signal is to be transmitted through the PSTN network on the basis of an input operation that a user has performed or a phone number of the remote communication apparatus; and a communication control unit that, when facsimile images are transmitted between the communication apparatus and the remote communication apparatus, makes the facsimile images transmitted at different communication speeds with respect to a case in which the received signal has been received through the IP network and a case in which the received signal has been received through the PSTN network, those cases being determined by the source end user communication network determination unit used when the signal is received, and that, when the facsimile images are transmitted between the communication apparatus and the remote communication apparatus, makes the facsimile images transmitted at different communication speeds with respect to a case in which the signal is to be transmitted through the IP network and a case in which the signal is to be transmitted through the PSTN network, those cases being determined by the source end user communication network determination unit used when the signal is transmitted.

According to the communication apparatus, the source end user communication network used by the communication apparatus when a signal is received or transmitted is specified and then the facsimile images are transmitted at different communication speeds depending on the specified source end user communication network. Accordingly, for example, it is possible to suppress communication errors from occurring by decreasing the communication speed when the signal is transmitted through the IP network in which delay occurs easily. In addition, it is possible to make the facsimile images transmitted quickly by increasing the communication speed when the signal is transmitted through the PSTN network in which delay does not occur easily.

Further, according to the aspect of the invention, it is preferable to further include: another end user communication network determination unit used when a signal is received that, when the signal is received from the remote communication apparatus, determines the type of another end user communication network on the basis of a phone number of the remote communication apparatus transmitted from another end user communication network; and another end user communication network determination unit used when a signal is transmitted that, when the signal is transmitted to the remote communication apparatus, determines the type of another end user communication network on the basis of a phone number of the remote communication apparatus. In addition, preferably, the communication control unit makes the facsimile images transmitted at different communication speeds depending on a combination of a determination result obtained by the source end user communication network determination unit used when the signal is received and a determination result obtained by another end user communication network determination unit used when the signal is received, and also makes the facsimile images transmitted at different communication speeds depending on a combination of a determination result obtained by the source end user communication network determination unit used when the signal is transmitted and a determination result obtained by another end user communication network determination unit used when the signal is transmitted.

Accordingly, it is possible to transmit the facsimile images in a communication speed in consideration of a characteristic of another end user communication network as well as a characteristic of the source end user communication network. As a result, in any combination of the source end user communication network and another end user communication network, it is possible to suppress communication errors from occurring and to make the facsimile images transmitted quickly.

Further, according to the second aspect of the invention, there is provided a program product causing a computer to function as each of the units included in the communication apparatus, the computer being included in the communication apparatus that is capable of communicating with a remote communication apparatus through a source end user communication network to which the communication apparatus is connected and another end user communication network to which the remote communication apparatus is connected and that is connected to a relay device connected to both an IP network and a PSTN network so that each of the IP network and the PSTN network can be used as the source end user communication network.

If the program product described above is used, the computer included in a communication apparatus can function as each of the units included in the communication apparatus according to any one of the first to fourteenth aspects of the invention. As a result, the communication apparatus can operate as described above and the effects described above can be obtained.

What is claimed is:

1. A voice processing device comprising:
a measurement unit that measures a voice volume level of a voice signal transmitted from a remote communication apparatus; and
a signal processing unit that, on the basis of a peak value of the voice volume level measured by the measurement unit, performs a signal processing determined according to the peak value with respect to a voice signal transmitted from/to the remote communication apparatus.

2. The voice processing device according to claim 1, wherein the signal processing unit performs at least one of a process of changing the voice volume level to a level determined according to the peak value and a process of changing a level of an echo cancellation to a level determined according to the peak value with respect to the voice signal transmitted from/to the remote communication apparatus.

3. The voice processing device according to claim 1, further comprising:
a peak value storage unit that stores the peak value;
a determination unit that determines whether or not the peak value stored in the peak value storage unit is to be updated on the basis of the peak value stored in the peak value storage unit and the peak value measured by the measurement unit; and
an updating unit that updates the peak value stored in the peak value storage unit to the peak value measured by the measurement unit when the determination unit determines that the peak value is to be updated,
wherein the signal processing unit performs the signal processing with respect to the voice signal transmitted from/to the remote communication apparatus on the basis of the peak value stored in the peak value storage unit.

4. The voice processing device according to claim 3, wherein the determination unit determines that the peak value stored in the peak value storage unit is to be updated when a difference between the peak value stored in the peak value storage unit and the peak value of the voice volume level measured by the measurement unit is equal to or larger than a predetermined value.

5. The voice processing device according to claim 3, wherein the determination unit determines that the peak value stored in the peak value storage unit is to be updated when the peak value of the voice volume level measured by the measurement unit is larger than a predetermined lowermost value.

6. A communication apparatus comprising a voice processing device that comprises:
a measurement unit that measures a voice volume level of a voice signal transmitted from a remote communication apparatus; and
a signal processing unit that, on the basis of a peak value of the voice volume level measured by the measurement unit, performs a signal processing determined according to the peak value with respect to a voice signal transmitted from/to the remote communication apparatus.

7. A program product for enabling a computer to perform predetermined operations, the predetermined operations including the steps of:
measuring a voice volume level of a voice signal transmitted from a remote communication apparatus; and
performing, on the basis of a peak value of the voice volume level measured by the measurement unit, a signal processing determined according to the peak value with respect to a voice signal transmitted from/to the remote communication apparatus.

8. A communication apparatus that is capable of communicating with a remote communication apparatus through a first communication network to which the communication apparatus is connected and a second communication network to which the remote communication apparatus is connected and is capable of being connected to a relay device connected to both an IP network and a PSTN network so that each of the IP network and the PSTN network can be used as the first communication network, the communication apparatus comprising:
a receiving-time first communication network determination unit that determines whether a signal received from the remote communication apparatus is received through the IP network or through the PSTN network when receiving the signal from the remote communication apparatus on the basis of a call notice signal transmitted from the first communication network or the relay device; and
a voice signal processing unit that performs different signal processing for voice signals transmitted between the communication apparatus and the remote communication apparatus with respect to a case in which the received signal has been received through the IP network and a case in which the received signal has been received through the PSTN network, those cases being determined by the receiving-time first communication network determination unit.

9. The communication apparatus according to claim 8, further comprising a receiving-time second communication network determination unit that determines a type of the second communication network when receiving the signal from the remote communication apparatus on the basis of a phone number of the remote communication apparatus transmitted from the second communication network,
wherein the voice signal processing unit performs different processing for the voice signals transmitted between the communication apparatus and the remote communication apparatus depending on a combination of determination results obtained by the receiving-time first communication network determination unit and the receiving-time second communication network determination unit.

10. A communication apparatus that is capable of communicating with a remote communication apparatus through a first communication network to which the communication apparatus is connected and a second communication network to which the remote communication apparatus is connected and is capable of being connected to a relay device connected to both an IP network and a PSTN network so that each of the IP network and the PSTN network can be used as the first communication network, the communication apparatus comprising:
a transmitting-time first communication network determination unit that determines whether a signal is to be transmitted through the IP network or through the PSTN network when transmitting the signal to the remote communication apparatus on the basis of an input operation that a user has performed or a phone number of the remote communication apparatus; and
a voice signal processing unit that performs different signal processing for voice signals transmitted between the communication apparatus and the remote communication apparatus with respect to a case in which the signal is to be transmitted through the IP network and a case in which the signal is to be transmitted through the PSTN network, those cases being determined by the transmitting-time first communication network determination unit.

11. The communication apparatus according to claim 10, further comprising a transmitting-time second communication network determination unit that determines a type of the second communication network when transmitting the signal to the remote communication apparatus on the basis of a phone number of the remote communication apparatus,
wherein the voice signal processing unit performs different signal processing for the voice signals transmitted between the communication apparatus and the remote communication apparatus depending on a combination of determination results obtained by the transmitting-time first communication network determination unit and the transmitting-time second communication network determination unit.

12. A communication apparatus that is capable of communicating with a remote communication apparatus through a first communication network to which the communication apparatus is connected and a second communication network to which the remote communication apparatus is connected and is capable of being connected to a relay device connected to both an IP network and a PSTN network so that each of the IP network and the PSTN network can be used as the first communication network, the communication apparatus comprising:
a receiving-time first communication network determination unit that determines whether a signal received from the remote communication apparatus is received through the IP network or through the PSTN network when receiving the signal from the remote communication apparatus on the basis of a call notice signal transmitted from the first communication network or the relay device;
a transmitting-time first communication network determination unit that determines whether a signal is to be transmitted through the IP network or through the PSTN network when transmitting the signal to the remote communication apparatus on the basis of an input operation that a user has performed or a phone number of the remote communication apparatus; and
a voice signal processing unit that performs different signal processing for voice signals transmitted between the communication apparatus and the remote communication apparatus with respect to a case in which the received signal has been received through the IP network and a case in which the received signal has been received through the PSTN network, those cases being determined by the receiving-time first communication network determination unit, the voice signal processing unit performing different signal processing for the voice signals transmitted between the communication apparatus and the remote communication apparatus with respect to a case in which the signal is to be transmitted through the IP network and a case in which the signal is to be transmitted through the PSTN network, those cases being determined by the transmitting-time first communication network determination unit.

13. The communication apparatus according to claim 12, further comprising:
a receiving-time second communication network determination unit that determines a type of the second communication network when receiving the signal from the remote communication apparatus on the basis of a phone number of the remote communication apparatus transmitted from the second communication network; and
a transmitting-time second communication network determination unit that determines a type of the second communication network when transmitting the signal to the remote communication apparatus on the basis of a phone number of the remote communication apparatus,
wherein the voice signal processing unit performs different signal processing for the voice signals transmitted between the communication apparatus and the remote communication apparatus depending on a combination of determination results obtained by the receiving-time first communication network determination unit and the receiving-time second communication network determination unit, the voice signal processing unit performing different signal processing for the voice signals transmitted between the communication apparatus and the remote communication apparatus depending on a combination of determination results obtained by the transmitting-time first communication network determination unit and the transmitting-time second communication network determination unit.

14. The communication apparatus according to claim 8, further comprising:
a during-communication first communication network determination unit that, when a signal is received from a second remote communication apparatus while the communication apparatus is in communication with a first communication apparatus, determines whether the signal received from the second remote communication apparatus is a signal received through the IP network or through the PSTN network on the basis of a call notice signal transmitted from the first communication network or the relay device,
wherein the voice signal processing unit performs different signal processing for voice signals transmitted between the communication apparatus and the second remote communication apparatus with respect to a case in which the signal received from the second remote communication apparatus has been received through the IP network and a case in which the signal received from the second remote communication apparatus has been received through the PSTN network, those cases being determined by the during-communication first communication network determination unit.

15. The communication apparatus according to claim 10, further comprising:
a during-communication first communication network determination unit that, when a signal is received from a second remote communication apparatus while the communication apparatus is in communication with a first communication apparatus, determines whether the signal received from the second remote communication apparatus is a signal received through the IP network or through the PSTN network on the basis of a call notice signal transmitted from the first communication network or the relay device,
wherein the voice signal processing unit performs different signal processing for voice signals transmitted between the communication apparatus and the second remote communication apparatus with respect to a case in which the signal received from the second remote communication apparatus has been received through the IP network and a case in which the signal received from the second remote communication apparatus has been received through the PSTN network, those cases being determined by the during-communication first communication network determination unit.

16. The communication apparatus according to claim 12, further comprising:
a during-communication first communication network determination unit that, when a signal is received from a second remote communication apparatus while the communication apparatus is in communication with a first communication apparatus, determines whether the signal received from the second remote communication apparatus is a signal received through the IP network or through the PSTN network on the basis of a call notice signal transmitted from the first communication network or the relay device,
wherein the voice signal processing unit performs different signal processing for voice signals transmitted between the communication apparatus and the second remote communication apparatus with respect to a case in which the signal received from the second remote communication apparatus has been received through the IP network and a case in which the signal received from the second remote communication apparatus has been received through the PSTN network, those cases being determined by the during-communication first communication network determination unit.

17. The communication apparatus according to claim 14, further comprising:
a during-communication second communication network determination unit that, when the signal is received from the second remote communication apparatus, determines a type of the second communication network on the basis of a phone number of the second remote communication apparatus transmitted from the second communication network,
wherein the voice signal processing unit performs different signal processing for voice signals transmitted between the communication apparatus and the second remote communication apparatus depending on a combination of determination results obtained by the during-communication first communication network determination unit and the during-communication second communication network determination unit.

18. The communication apparatus according to claim 15, further comprising:
a during-communication second communication network determination unit that, when the signal is received from the second remote communication apparatus, determines a type of the second communication network on the basis of a phone number of the second remote communication apparatus transmitted from the second communication network,
wherein the voice signal processing unit performs different signal processing for voice signals transmitted between the communication apparatus and the second remote communication apparatus depending on a combination of determination results obtained by the during-communication first communication network determination unit and the during-communication second communication network determination unit.

19. The communication apparatus according to claim 16, further comprising:
a during-communication second communication network determination unit that, when the signal is received from the second remote communication apparatus, determines a type of the second communication network on the basis of a phone number of the second remote communication apparatus transmitted from the second communication network,
wherein the voice signal processing unit performs different signal processing for voice signals transmitted between the communication apparatus and the second remote communication apparatus depending on a combination of determination results obtained by the during-communication first communication network determination unit and the during-communication second communication network determination unit.

20. A communication apparatus that has a facsimile function and is capable of communicating with a remote communication apparatus through a first communication network to which the communication apparatus is connected and a second communication network to which the remote communication apparatus is connected and is capable of being connected to a relay device connected to both an IP network and a PSTN network so that each of the IP network and the PSTN network can be used as the first communication network, the communication apparatus comprising:
a receiving-time first communication network determination unit that determines whether a signal received from the remote communication apparatus is received through the IP network or through the PSTN network when receiving the signal from the remote communication apparatus on the basis of a call notice signal transmitted from the first communication network or the relay device; and
a communication control unit that, when a facsimile image is transmitted between the communication apparatus and the remote communication apparatus, makes the facsimile image transmitted at different communication speeds with respect to a case in which the received signal has been received through the IP network and a case in which the received signal has been received through the PSTN network, those cases being determined by the receiving-time first communication network.

21. The communication apparatus according to claim 20, further comprising a receiving-time second communication network determination unit that determines a type of the second communication network when receiving the signal from the remote communication apparatus on the basis of a phone number of the remote communication apparatus transmitted from the second communication network,
wherein the communication control unit makes the facsimile image transmitted at different communication speeds depending on a combination of determination results obtained by the receiving-time first communication network determination unit and the receiving-time second communication network determination unit.

22. A communication apparatus that has a facsimile function and is capable of communicating with a remote communication apparatus through a first communication network to which the communication apparatus is connected and a second communication network to which the remote communication apparatus is connected and is capable of being connected to a relay device connected to both an IP network and a PSTN network so that each of the IP network and the PSTN network can be used as the first communication network, the communication apparatus comprising:
a transmitting-time first communication network determination unit that determines whether a signal is to be transmitted through the IP network or through the PSTN network when transmitting the signal to the remote communication apparatus on the basis of an input operation that a user has performed or a phone number of the remote communication apparatus; and
a communication control unit that, when a facsimile image is transmitted between the communication apparatus and the remote communication apparatus, makes the facsimile image transmitted at different communication speeds with respect to a case in which the signal is to be transmitted through the IP network and a case in which the signal is to be transmitted through the PSTN network, those cases being determined by the transmitting-time first communication network determination unit.

23. The communication apparatus according to claim 22, further comprising a transmitting-time second communication network determination unit that determines a type of the second communication network when transmitting the signal to the remote communication apparatus on the basis of a phone number of the remote communication apparatus, wherein the communication control unit makes the facsimile image transmitted at different communication speeds depending on a combination of determination results obtained by the transmitting-time first communication network determination unit and the transmitting-time second communication network determination unit.

24. A communication apparatus that has a facsimile function and is capable of communicating with a remote communication apparatus through a first communication network to which the communication apparatus is connected and a second communication network to which the remote communication apparatus is connected and is capable of being connected to a relay device connected to both an IP network and a PSTN network so that each of the IP network and the PSTN network can be used as the first communication network, the communication apparatus comprising:
a receiving-time first communication network determination unit that determines whether a signal received from the remote communication apparatus is received through the IP network or through the PSTN network when receiving the signal from the remote communication apparatus on the basis of a call notice signal transmitted from the first communication network or the relay device;
a transmitting-time first communication network determination unit that determines whether a signal is to be transmitted through the IP network or through the PSTN network when transmitting the signal to the remote communication apparatus on the basis of an input operation that a user has performed or a phone number of the remote communication apparatus; and
a communication control unit that, when a facsimile image is transmitted between the communication apparatus and the remote communication apparatus, makes the facsimile image transmitted at different communication speeds with respect to a case in which the received signal has been received through the IP network and a case in which the received signal has been received through the PSTN network, those cases being determined by the receiving-time first communication network determination unit, the communication control unit making, when the facsimile image is transmitted between the communication apparatus and the remote communication apparatus, the facsimile image transmitted at different communication speeds with respect to a case in which the signal is to be transmitted through the IP network and a case in which the signal is to be transmitted through the PSTN network, those cases being determined by the transmitting-time first communication network determination unit used when the signal is transmitted.

25. The communication apparatus according to claim 24, further comprising:
a receiving-time second communication network determination unit that determines a type of the second communication network when receiving the signal from the remote communication apparatus on the basis of a phone number of the remote communication apparatus transmitted from the second communication network; and
a transmitting-time second communication network determination unit that determines a type of the second communication network when transmitting the signal to the remote communication apparatus on the basis of a phone number of the remote communication apparatus,
wherein the communication control unit makes the facsimile image transmitted at different communication speeds depending on a combination of determination results obtained by the receiving-time first communication network determination unit and the receiving-time second communication network determination unit used when the signal is received, and the communication control unit makes the facsimile image transmitted at different communication speeds depending on a combination of determination results obtained by the transmitting-time first communication network determination unit and the transmitting-time second communication network determination unit.

26. A program product for enabling a computer of a communication apparatus, which is capable of communicating with a remote communication apparatus through a first communication network to which the communication apparatus is connected and a second communication network to which the remote communication apparatus is connected and is capable of being connected to a relay device connected to both an IP network and a PSTN network so that each of the IP network and the PSTN network can be used as the first communication network, to perform predetermined operations, the predetermined operations including the steps of:
determining whether a signal received from the remote communication apparatus is received through the IP network or through the PSTN network when receiving the signal from the remote communication apparatus on the basis of a call notice signal transmitted from the first communication network or the relay device; and
performing different signal processing for voice signals transmitted between the communication apparatus and the remote communication apparatus with respect to a case in which the received signal has been received through the IP network and a case in which the received signal has been received through the PSTN network.

27. A program product for enabling a computer of a communication apparatus, which is capable of communicating with a remote communication apparatus through a first communication network to which the communication apparatus is connected and a second communication network to which the remote communication apparatus is connected and is capable of being connected to a relay device connected to both an IP network and a PSTN network so that each of the IP network and the PSTN network can be used as the first communication network, to perform predetermined operations, the predetermined operations including the steps of:
determining whether a signal is to be transmitted through the IP network or through the PSTN network when transmitting the signal to the remote communication apparatus on the basis of an input operation that a user has performed or a phone number of the remote communication apparatus; and
performing different signal processing for voice signals transmitted between the communication apparatus and the remote communication apparatus with respect to a case in which the signal is to be transmitted through the IP network and a case in which the signal is to be transmitted through the PSTN network.

28. A program product for enabling a computer of a communication apparatus, which is capable of communicating with a remote communication apparatus through a first communication network to which the communication apparatus is connected and a second communication network to which the remote communication apparatus is connected and is capable of being connected to a relay device connected to both an IP network and a PSTN network so that each of the IP network and the PSTN network can be used as the first communication network, to perform predetermined operations, the predetermined operations including the steps of:
determining whether a signal received from the remote communication apparatus is received through the IP network or through the PSTN network when receiving the signal from the remote communication apparatus on the basis of a call notice signal transmitted from the first communication network or the relay device;
determining whether a signal is to be transmitted through the IP network or through the PSTN network when transmitting the signal to the remote communication apparatus on the basis of an input operation that a user has performed or a phone number of the remote communication apparatus; and
performing different signal processing for voice signals transmitted between the communication apparatus and the remote communication apparatus with respect to a case in which the received signal has been received through the IP network and a case in which the received signal has been received through the PSTN network, and performing different signal processing for the voice signals transmitted between the communication apparatus and the remote communication apparatus with respect to a case in which the signal is to be transmitted through the IP network and a case in which the signal is to be transmitted through the PSTN network.

29. A program product for enabling a computer of a communication apparatus, which has a facsimile function and is capable of communicating with a remote communication apparatus through a first communication network to which the communication apparatus is connected and a second communication network to which the remote communication apparatus is connected and is capable of being connected to a relay device connected to both an IP network and a PSTN network so that each of the IP network and the PSTN network can be used as the first communication network, to perform predetermined operations, the predetermined operations including the steps of:
determining whether a signal received from the remote communication apparatus is received through the IP network or through the PSTN network when receiving the signal from the remote communication apparatus on the basis of a call notice signal transmitted from the first communication network or the relay device; and
making, when a facsimile image is transmitted between the communication apparatus and the remote communication apparatus, the facsimile image transmitted at different communication speeds with respect to a case in which the received signal has been received through the IP network and a case in which the received signal has been received through the PSTN network.

30. A program product for enabling a computer of a communication apparatus, which has a facsimile function and is capable of communicating with a remote communication apparatus through a first communication network to which the communication apparatus is connected and a second communication network to which the remote communication apparatus is connected and is capable of being connected to a relay device connected to both an IP network and a PSTN network so that each of the IP network and the PSTN network can be used as the first communication network, to perform predetermined operations, the predetermined operations including the steps of:
determining whether a signal is to be transmitted through the IP network or through the PSTN network when transmitting the signal to the remote communication apparatus on the basis of an input operation that a user has performed or a phone number of the remote communication apparatus; and
making, when a facsimile image is transmitted between the communication apparatus and the remote communication apparatus, the facsimile image transmitted at different communication speeds with respect to a case in which the signal is to be transmitted through the IP network and a case in which the signal is to be transmitted through the PSTN network.

31. A program product for enabling a computer of a communication apparatus, which has a facsimile function and is capable of communicating with a remote communication apparatus through a first communication network to which the communication apparatus is connected and a second communication network to which the remote communication apparatus is connected and is capable of being connected to a relay device connected to both an IP network and a PSTN network so that each of the IP network and the PSTN network can be used as the first communication network, to perform predetermined operations, the predetermined operations including the steps of:
determining whether a signal received from the remote communication apparatus is received through the IP network or through the PSTN network when receiving the signal from the remote communication apparatus on the basis of a call notice signal transmitted from the first communication network or the relay device;
determining whether a signal is to be transmitted through the IP network or through the PSTN network when transmitting the signal to the remote communication apparatus on the basis of an input operation that a user has performed or a phone number of the remote communication apparatus; and
making, when a facsimile image is transmitted between the communication apparatus and the remote communication apparatus, the facsimile image transmitted at different communication speeds with respect to a case in which the received signal has been received through the IP network and a case in which the received signal has been received through the PSTN network, and making, when the facsimile image is transmitted between the communication apparatus and the remote communication apparatus, the facsimile image transmitted at different communication speeds with respect to a case in which the signal is to be transmitted through the IP network and a case in which the signal is to be transmitted through the PSTN network.
